(19) United States
(12) Patent Application Publication
(10) Pub. No.: US 2015/0075103 A2
(43) Pub. Date: Mar. 19, 2015

(54) CONSTRUCTION SYSTEM AND COMPONENTS THEREFOR

(71) Applicant: Reginald Arthur Richards, Christchurch (NZ)

(72) Inventor: Reginald Arthur Richards, Christchurch (NZ)

(73) Assignee: RCP Holdings Limited, Christchurch (NZ)

(21) Appl. No.: 13/995,799

(22) PCT Filed: Dec. 22, 2010
(86) PCT No.: PCT/IB2010/056002

§ 371 Date: Sep. 5, 2013

(51) Int. Cl. E04C 2/04; E04B 7/20; E04B 2/06; E04B 5/02; F16L 5/00; E04B 1/04

(52) U.S. Cl. CPC E04C 2/044; F16L 5/00; E04B 1/04; E04B 2/06; E04B 5/02; E04B 7/20
USPC 52/578; 428/189; 428/70; 428/172; 428/174; 428/34.4; 428/157; 428/411.1; 137/360

(57) ABSTRACT

A modular construction system for quick and convenient construction of buildings, comprising construction panels generally in the order of 600 m wide. The modular construction system includes construction panels, framed construction panels, lintel panels, and framed lintel panels, that together allow a wide variety of building configurations to be assembled. The construction panel includes a cast cement wall member and partially embedded channel shaped sheet steel support members, with the wall member defining an extended portion that extends from the support member to the edge of a major face of the wall member. The framed construction panels is 600 mm wide and includes shaped sheet steel support members extending from a major face at least partially around its periphery.

### TECHNICAL FIELD

The present invention relates to a construction system. More particularly but not exclusively it relates to a modular construction system and components therefor, for facilitating construction of residential and business units.

### BACKGROUND OF THE INVENTION

Modular construction system are known and used worldwide. The main features of modular construction systems which make them desirable are that they may be mass produced off site, which allows for stockpiling and increased availability of components, are quickly installed, and may be relatively low in cost.

However, many modular construction systems may have undesirable features in that they may be heavy and may need to be installed by specialised heavy construction equipment such as cranes, they may be damaged by heavy weather, and they may not always provide adequate insulation. Further, such modular systems may not be vermin and insect resistant, humidity resistant, fireproof, and may require extensive regular maintenance. Further, buildings assembled using such systems may be easily damaged.

Known modular building systems include prefabricated concrete walls which are secured in an engaged relationship by nuts and bolts. Such concrete walls may include rigid inserts which are moulded into the concrete. An example of such prior art is illustrated in U.S. Pat. No. 5,526,629. This publication shows a composite building panel comprising a pre-cast concrete wall incorporating steel support members spaced regularly in parallel along its length, and around the perimeter edges of one of its major faces.

The support members extend from within the pre-cast concrete portion towards what would be the inside of the house. The support members provide attachment points for wallboard, and to provide cavities within which plumbing and electrical wiring may be laid. However, a disadvantage of such a system is that the combined weight of the frames and the concrete pre-cast portion is excessive and requires heavy duty machinery to assemble, and the positioning of the extended frame sections around the perimeter is a hindrance to the presentation of a clean concrete surface to what would be the outer side of the wall, especially where two building panels meet at a corner. Further, a system as shown in U.S. Pat. No. 5,526,629 is intended to replace an entire wall section, and does not easily lend itself to the construction of double story constructions and more modular applications.

Another disadvantage of known systems further may not allow for the construction system and processes to be integrated with known non-modular construction systems and processes, such as interior framing and roofing methods.

For the purposes of this specification, the term “plastic” shall be construed to mean a general term for a wide range of synthetic or semisynthetic polymerization products, and generally consisting of a hydrocarbon-based polymer.

For the purposes of this specification, the term “concrete” shall be construed to mean a general term for a wide range of products formed by the coalescence of particles, and which may or may not include cement, sand, gravel, ash, slag, alumina, or any other lightweight or heavy aggregates such as plastic or metal fibres, polystyrene, and may specifically include aerated or lightweight cementitious products.

For the purposes of this specification, the term “drywall member” is defined to mean a sheet of dry walling, ceiling board, floor covering or any similar sheet like or planar material of any composition.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### OBJECT OF THE INVENTION

It is an object of the present invention to provide a modular construction system and components therefor which overcomes or at least ameliorates some of the abovementioned disadvantages or which at least provides the public with a useful choice.

### SUMMARY OF THE INVENTION

According to one aspect, the invention may be said to consist in a construction panel suitable for use in a modular construction process, said construction panel comprising

a cast concrete wall member defining two opposed major faces and at least one edge;

at least one partially embedded support member extending from one major face of the wall member at a distance from at least one edge of at least one major face.

Preferably, the wall member defines a plurality of edges.

Preferably, at least part of at least one of the edges of the major faces is at least partially unimpeded.

Preferably, the support member extends from one major face of the wall member at a distance of between 10-200 mm from the edge of the major face.

Preferably, the support member extends from one major face of the wall member at a distance of between 30-100 mm from the edge of the major face.

Preferably, the support member extends from one major face of the wall member at a distance of about 45 mm from the edge of the major face.

Preferably, the support member extends from one major face of the wall member at a distance of about 60 mm from the edge of the major face.

Preferably, the extension of the wall member between the support member and the edge of the wall member defines an extended portion.

Preferably, the extended portion is a linear lip.

Preferably, the extended portion of the wall member extends around a plurality of edges of the wall member.

Preferably, the extended portion of the wall member extends around all the edges of the wall member.

Preferably, the construction panel comprises support members extending along the length of opposed edges of the wall member, and the support members extend from the major face of the wall member at unequal distances from the respective edges of the major face.

Preferably, the construction panel further comprises at least one partially embedded framing support member extending from one major face of the wall member at at least one edge of at least one major face.

Preferably, the extended portion extends around at least some of the edges of the wall member, and a framing support member extends around at least one of the remaining edges of the wall member at the edge of the wall member.

Preferably, the framing support member and the support member are connected to each other.

Preferably, the wall member is substantially rectilinear in shape.

Preferably, the wall member is rectangular in shape.

Preferably, at least one support member is substantially L-shaped in cross section.

Preferably, at least one support member is substantially C-shaped in cross section.

Preferably, at least one support member is substantially channel shaped in cross section.

Preferably, the wall member includes internal reinforcing inserts.

Preferably, the extended portion of the wall member includes reinforcing inserts.

Preferably, the construction panel comprises reinforcing inserts that extend between the extended portion and the rest of the wall member.

Preferably, the reinforcing inserts extend at least partially from the wall member as securing extensions.

Preferably, the reinforcing inserts are composed of metal.

Preferably, the reinforcing inserts are composed of reinforcing bar.

Preferably, the reinforcing inserts include metal meshing.

Preferably, the reinforcing inserts are composed of a fibrous composition.

Preferably, the reinforcing inserts are composed of glass fibre.

Preferably, the reinforcing inserts are pre-stressed.

Preferably, the support member is composed of metal.

Preferably, the support member is composed of a fibrous composition.

Preferably, the support member is composed of one selected from glass fibre;

carbon fibre; or the like.

Preferably, the support member is composed of a pultruded fibre composition.

Preferably, the support member is composed of a pultruded glass fibre material.

Preferably, the construction process is a building construction process.

Preferably, a support member extends along one edge of the wall member, and one selected from a support member and a framing support member extends along an opposed edge of the wall member.

Preferably, the width of the extended portion between the support member and the edge of the wall member is between 100-150 mm.

Preferably, the width of the extended portion between the support member and the edge of the wall member is about 135 mm.

Preferably, the width of the wall member from edge to edge is between 300-900 mm.

Preferably, the width of the wall member is between 500-700 mm.

Preferably, the width of the wall member is about 600 mm.

Preferably, the cast planar wall member is between 1.5 and 3.5 meters long.

Preferably, the cast planar wall member is between 2 and 3 meters long.

Preferably, the cast planar wall member is about 2.5 long.

Preferably, the cast planar wall member has a thickness of between 30-100 mm.

Preferably, the cast planar wall member has a thickness of between 40-80 mm.

Preferably, the cast planar wall member has a thickness of about 55 mm.

Preferably, the construction panel includes securing formations for allowing cladding elements to be secured to at least one major face of the wall panel.

Preferably, the support members include batten support formations for supporting support battens.

Preferably, the framing support members include batten support formations for supporting support battens.

Preferably, the construction panel further comprises an integrally formed heating arrangement.

Preferably, the heating arrangement includes a length of piping suitable for the passage of heated fluid, with an inlet passage and an outlet passage.

Preferably, the piping is configured as several lengths of parallel pipes connected to each other.

Preferably, the construction panel further comprises lifting formations for lifting the construction panel during installation.

Preferably, one or more of the support members and the framing support members is composed of sheet metal.

Preferably, one or more of the support members and the framing support members are composed of galvanised sheet metal.

Preferably, one or more of the support members and the framing support members is composed of sheet steel.

Preferably, one or more of the support members and the framing support members are composed of galvanised sheet steel.

Preferably, the sheet metal gauge is between 0.3 and 3.0 millimetres.

Preferably, the sheet metal gauge is about 0.5 millimetres.

Preferably, the wall member includes a recess along an edge adapted for operationally receiving a sealing arrangement.

Preferably, the recess is along an edge on a major face opposed to the major face from which the support members extend.

Preferably, the wall member includes a recess along at least one minor face, said recess adapted for operationally receiving a scaling arrangement.

According to another aspect, the invention may be said to consist in a construction panel suitable for use in a modular construction process, said construction panel comprising

a cast planar wall member defining two opposed major faces;

at least one partially embedded support member most proximate an edge of the wall member extending from one major face of the wall member;

wherein the wall member extends outwardly along the plane of the wall member from the support member to define an extended portion.

Preferably, the edges of the extended portion are unimpeded, to thereby allow for the snug engagement of the extended portion against one or more selected from the group of

construction framing;

the extended portion of a similar construction panel;

the support member of a similar construction panel; and

an edge of a floor construction.

According to another aspect, the invention may be said to consist in a lintel panel suitable for use in a construction together with a construction panel as claimed in any of claims 1-66, said lintel panel comprising

a cast planar wall member defining two opposed major faces and at least one minor face;

at least one partially embedded support member extending from one major face of the wall member proximate an edge of the wall member,

wherein the wall member extends outwardly along the plane of the wall member from the support member to define an extended portion;

and wherein the wall member has a length of approximately one tenth to two thirds of said construction panel to enable the lintel panel to be secured adjacent a construction panel to present an opening in the construction suitable for a window.

Preferably, the wall member includes internal reinforcing inserts.

Preferably, the extended portion of the wall member includes reinforcing inserts.

Preferably, the wall member includes reinforcing inserts that extend between the extended portion and the rest of the wall member.

Preferably, the reinforcing inserts extend at least partially from the wall member as securing extensions.

Preferably, the reinforcing inserts are composed of metal.

Preferably, the reinforcing inserts are composed of reinforcing bar (or “rebar’).

Preferably, the reinforcing inserts include metal meshing.

A lintel panel as claimed in any of claims 68 to 71, wherein the reinforcing inserts are composed of a fibrous composition.

Preferably, the reinforcing inserts are composed of glass fibre.

Preferably, the reinforcing inserts are pre-stressed.

Preferably, the support member is composed of metal.

Preferably, the support member is composed of a fibrous composition.

Preferably, the support member is composed of one selected from

glass fibre;

carbon fibre;

or the like.

Preferably, the support member is composed of a pultruded fibre composition.

Preferably, the support member is composed of a pultruded glass fibre material.

Preferably, the width of the wall member is between 300 mm and 900 mm.

Preferably, the width of the wall member is between 500 mm and 700 mm.

Preferably, the width of the wall member is about 600 mm.

Preferably, the lintel panel further comprises at least one or more framing support members extending from one major face of the wall member along at least part of an edge of the wall member.

Preferably, the support members include batten support formations for supporting support battens.

Preferably, the framing support members include batten support formations for supporting support battens.

Preferably, the lintel panel further comprises lifting formations for lifting the construction panel.

Preferably, one or more of the support members and the framing support members is composed of sheet metal.

Preferably, one or more of the support members and the framing support members is composed of galvanised sheet metal.

Preferably, one or more of the support members and the framing support members is composed of galvanised sheet steel.

Preferably, the sheet metal gauge is between 0.3 and 3.0 millimetres.

Preferably, the sheet metal gauge is about 0.5 millimetres.

Preferably, the wall member includes a recess along an edge adapted for operationally receiving a sealing arrangement.

Preferably, the recess is along an edge on a major face opposed to the major face from which the support members extend.

Preferably, the wall member includes a recess along at least one of its minor faces adapted for operationally receiving a sealing arrangement.

According to another aspect, the invention may be said to consist in a framed construction panel comprising

a cast planar wall member defining two opposed major faces and at least one minor face; and

a pair of partially embedded framing support members extending from at least one major face of the wall member proximate opposed edges of the wall member;

wherein the width of the wall member is between 300 mm and 900 mm.

Preferably, the width of the wall member is between 500 mm and 700 mm.

Preferably, the width of the wall member is about 600 mm.

Preferably, the cast planar wall member is between 1.5 and 3.5 meters long.

Preferably, the cast planar wall member is between 2 and 3 meters long.

Preferably, the cast planar wall member is about 2.5 long.

Preferably, the cast planar wall member has a thickness of between 30-100 mm.

Preferably, the cast planar wall member has a thickness of between 40-80 mm.

Preferably, the cast planar wall member has a thickness of 55 mm.

Preferably, the wall member includes internal reinforcing inserts.

Preferably, the reinforcing inserts extend at least partially from the wall member as securing extensions.

Preferably, the reinforcing inserts are composed of metal.

Preferably, the reinforcing inserts are composed of reinforcing bar (or “rebar”).

Preferably, the reinforcing inserts include metal meshing.

Preferably, the reinforcing inserts are composed of a fibrous composition.

Preferably, the reinforcing inserts are composed of glass fibre.

Preferably, the reinforcing inserts are pre-stressed.

Preferably, the framing support member is composed of a fibrous composition.

Preferably, the framing support member is composed of one selected from

glass fibre;

carbon fibre;

or the like.

Preferably, the framing support member is composed of a pultruded fibre composition.

Preferably, the framing support member is composed of a pultruded glass fibre material.

Preferably, the framed construction panel includes securing formations for allowing cladding elements to be secured to at least one major face of the wall panel.

Preferably, the framing support members include batten support formations for supporting support battens.

Preferably, the framed construction panel further comprises a heating arrangement.

Preferably, the framed construction panel further comprises an integrally formed heating arrangement.

Preferably, the heating arrangement includes a length of piping suitable for the passage of heated fluid, with an inlet passage and an outlet passage.

Preferably, the piping is configured as several lengths of parallel pipes connected to each other.

Preferably, the framed construction panel further comprises lifting formations for lifting the construction panel.

Preferably, one or more of the framing support members is composed of metal.

Preferably, one or more of the framing support members comprises sheet metal.

Preferably, one or more of the support members and the framing support members comprise galvanised sheet metal.

Preferably, the sheet metal gauge is between 0.5 and 3.0 millimetres.

Preferably, the sheet metal gauge is about 0.5 millimetres.

Preferably, the wall member includes a recess along an edge adapted for operationally receiving a scaling arrangement.

Preferably, the recess is along an edge on a major face opposed to the major face from which the framing support members extend.

Preferably, the wall member includes a recess along at least one of its minor faces.

According to another aspect, the invention may be said to consist in a framed lintel panel suitable for use in a construction together with one or more selected from a construction panel as claimed in any of claims 1 to 66, a lintel panel as claimed in any of claims 67-97, and a framed construction panel as claimed in any of claims 98 to 133, said lintel panel comprising:

a cast planar wall member defining two opposed major faces and a minor face;

a pair of partially embedded framing support members extending from one major face of the wall member proximate opposed edges of the wall member;

wherein the inside width of the wall member is between 300 mm and 900 mm;

and wherein the wall member has a length of approximately one tenth to two thirds of one selected from said construction panel and the framed construction panel to enable the lintel panel to be secured adjacent a construction panel to present an opening in the construction suitable for a window.

Preferably, the width of the wall member is between 500 mm and 700 mm.

Preferably, the width of the wall member is about 600 mm.

Preferably, the wall member includes internal reinforcing inserts.

Preferably, the reinforcing inserts extend at least partially from the wall member as securing extensions.

Preferably, the reinforcing inserts are composed of metal.

Preferably, the reinforcing inserts are composed of reinforcing bar (or “rebar’).

Preferably, the reinforcing inserts include metal meshing.

Preferably, the reinforcing inserts are composed of a fibrous composition.

Preferably, the reinforcing inserts are composed of glass fibre.

Preferably, the reinforcing inserts are pre-stressed.

Preferably, the framing support member is composed of metal.

Preferably, the framing support member is composed of a fibrous composition.

Preferably, the framing support member is composed of one selected from

glass fibre;

carbon fibre;

or the like.

Preferably, the framing support member is composed of a pultruded fibre composition.

Preferably, the framing support member is composed of a pultruded glass fibre material.

Preferably, the framing support members include batten support formations for supporting support battens.

Preferably, the framed lintel panel further comprises lifting formations for lifting the framed construction panel.

Preferably, one or more of the framing support members comprises sheet metal.

Preferably, one or more of the framing support members comprises bent or formed sheet metal.

Preferably, one or more of the support members and the framing support members comprise galvanised sheet metal.

Preferably, the sheet metal gauge is between 0.3 and 3.0 millimetres.

Preferably, the sheet metal gauge is about 0.5 millimetres.

Preferably, the wall member includes a recess along an edge adapted for operationally receiving a sealing arrangement.

Preferably, the recess is along an edge on a major face opposed to the major face from which the framing support members extend.

Preferably, the wall member includes a recess along at least one minor face for operationally receiving a sealing arrangement.

According to another aspect, the invention may be said to consist in a wall construction comprising

at least a plurality of construction panels as described disposed with the edges of the major faces of adjacent planar wall members at least partially abutting each other, and

a structural member disposed intermediate the support members most proximate the abutting edges of the adjacent wall members;

wherein the construction panels are secured or securable to the structural member by at least one securing arrangement.

Preferably, the wall construction comprises, at a position secured along at least part of an edge of a major face of at least one construction panel, one or more selected from

a framed lintel panel as claimed in any of claims 134 to 159;

a lintel panel as claimed in any of claims 67 to 97; and

a framed construction panel as claimed in any of claims 98 to 133.

Preferably, the wall construction comprises a plurality of construction panels disposed with an edge of the major faces of adjacent wall members proximate each other.

Preferably, the wall construction comprises a plurality of construction panels disposed with the minor faces of adjacent wall members abutting each other.

Preferably, the wall construction comprises a framed construction panel secured to an adjacent construction panel along an edge of a major face of their wall members.

Preferably, the wall construction comprises a framed construction panel secured to an adjacent construction panel with the minor faces of their adjacent wall panels abutting each other.

A wall construction as claimed in any of claims 160 to 165, wherein the wall construction comprises a lintel panel secured along an edge of a major face of at least one selected from a construction panel and a framed construction panel.

Preferably, the securing arrangement is one or more selected from

a nut and bolt arrangement;

a clip arrangement; and

a rivet-type arrangement.

Preferably, the wall construction includes a mounting arrangement secured between two support members of adjacent construction panels.

Preferably, the wall construction comprises a plurality of mounting arrangements mounted between adjacent pairs of construction panels.

Preferably, the wall construction further comprises support battens mounted between at least two mounting arrangements.

Preferably, the wall construction comprises a drywall member mounted to the support battens.

Preferably, the wall construction comprises an insulative layer between the drywall member and the support members.

Preferably, the insulative layer is a plastic layer.

Preferably, the insulative layer is a polystyrene or similar layer.

Preferably, the wall construction comprises a load bearing mounting arrangement mounted to at least one support member.

Preferably, the wall construction further comprises a supporting structural formation comprising an upper supporting surface defining an edge formation; and

wherein at least one support member extends substantially horizontally from the wall panel and is supported by the upper supporting surface construction panel, and the extended portion of said construction panel extends downwardly past the edge formation to below the upper supporting surface.

Preferably, the wall construction includes a sealing arrangement between adjacent construction panels and/or adjacent construction panels and framed construction panels.

Preferably, the sealing arrangement comprises a sealing member received into a combined recess formed by adjacent recesses of adjacent panels.

Preferably, the scaling arrangement comprises a settable scaling filler composition received into a combined recess formed by adjacent recesses of adjacent construction panels.

According to another aspect, the invention may be said to consist in a wall construction comprising

a supporting structural formation comprising an upper supporting surface defining an edge formation; and

at least one construction panel as claimed in any of claims 1 to 66,

wherein said support member extends substantially horizontally from the wall member and is supported by the upper supporting surface, and the extended portion of the construction panel extends downwardly past the edge formation to below the upper supporting surface.

Preferably, the wall construction includes a securing arrangement for securing the support member to the supporting structural formation.

Preferably, the wall member is distanced from the edge of the supporting structural formation to provide ventilation through the wall construction.

Preferably, the wall construction comprises one or more selected from

a framed lintel panel as claimed in any of claims 134 to 159;

a lintel panel as claimed in any of claims 67 to 97; and

a framed construction panel as claimed in any of claims 98 to 133.

According to another aspect, the invention may be said to consist in a floor construction comprising

a supporting structural formation comprising an upper supporting surface defining an edge formation; and

at least one construction panel as claimed in any of claims 1 to 66;

wherein said construction panel is disposed with its

extended portion abutting against the upper supporting surface to support the wall member vertically, and

said support member abutting against the edge formation of the supporting structural formation.

Preferably, the floor construction comprises one or more selected from

a framed lintel panel as claimed in any of claims 134 to 159;

a lintel panel as claimed in any of claims 67 to 97; and

a framed construction panel as claimed in any of claims 98 to 133.

Preferably, the floor construction comprises a plurality of construction panels disposed with an edge of the major faces of adjacent wall members proximate each other.

Preferably, the floor construction comprises a plurality of construction panels disposed with the minor faces of adjacent wall members abutting each other.

Preferably, the floor construction comprises at least one framed construction panel secured along an edge of a major face of at least one construction panel.

Preferably, the plurality of construction panels disposed with an edge of their major faces proximate each other are secured to each other by a securing arrangement at abutting support members.

Preferably, securing extensions extend from adjacent wall members between the adjacent wall members.

Preferably, the securing extensions are secured to a supporting structural formation.

Preferably, the securing extensions are secured to a supporting structural formation by being cast in place in situ.

Preferably, the floor construction also acts as a ceiling construction for a construction level below the floor construction.

Preferably, the floor construction includes a mounting arrangement secured to at least two support members of adjacent construction panels.

Preferably, the floor construction further comprises support battens mounted between at least two mounting arrangements.

Preferably, the wall construction comprises a drywall member mounted to the support battens.

Preferably, the wall construction comprises a drywall member mounted to the support members.

Preferably, the wall construction comprises one or more selected from a thermally insulative layer and an electrically insulative layer between the drywall member and the support members.

Preferably, the insulative layer is a plastic layer.

Preferably, the insulative layer is a polystyrene or similar layer.

Preferably, the floor construction comprises a load bearing mounting arrangement mounted to the support member.

Preferably, the floor construction includes a sealing arrangement between adjacent construction panels and/or adjacent construction panels and framed construction panels.

Preferably, the sealing arrangement comprises a sealing member received into a combined recess formed by adjacent recesses of adjacent panels.

Preferably, the sealing arrangement comprises a settable sealing filler composition received into a combined recess formed by adjacent recesses of adjacent panels.

According to another aspect, the invention may be said to consist in a roof construction comprising

a plurality of construction panels as claimed in any of claims l-66 above disposed with the edges of the major faces of adjacent planar wall members proximate each other, and

a structural member disposed intermediate the support members most proximate the abutting edges of the adjacent wall members; and

wherein the construction panels are secured to the structural member by means of a securing arrangement.

Preferably, the roof construction comprises one or more selected from

a framed lintel panel as claimed in any of claims 134 to 159;

a lintel panel as claimed in any of claims 67 to 97; and

a framed construction panel as claimed in any of claims 98 to 133.

Preferably, the roof construction comprises a plurality of construction panels disposed with an edge of the major faces of adjacent wall members proximate each other.

Preferably, the roof construction comprises a plurality of construction panels disposed with an edge of the major faces of adjacent wall members overlapping each other.

Preferably, the extended portion of the wall members overlap with a proximate wall member.

Preferably, the roof construction includes at least one securing arrangement for securing one selected from the construction panel and the framed construction panel to one selected from a construction panel and a framed construction panel at adjacent framing support members.

Preferably, the roof construction includes fastening means for fastening the roof construction to a wall.

Preferably, the fastening means is a collar tie.

Preferably, the roof construction includes a mounting arrangement secured on each of at least a plurality of support members.

Preferably, the roof construction further comprises support battens mounted between at least two mounting arrangements.

Preferably, the roof construction comprises a drywall member mounted to the support battens.

Preferably, the wall construction comprises a drywall member mounted to the support members.

Preferably, the planar wall member encloses a cavity between the wall member and the drywall member suitable for installation of insulative material.

Preferably, the roof construction comprises a load bearing mounting arrangement mounted to the support member.

Preferably, the roof construction comprises a cladding element secured to a major face of the wall member.

Preferably, the roof construction includes a mounting bracket for mounting the roof construction to one selected from an adjacent wall construction and an adjacent framed wall construction.

Preferably, at least one of the cast planar wall members is moulded to resemble a plurality of roof tiles on at least one side.

Preferably, the roof construction includes a sealing arrangement between adjacent one selected from the construction panel and the framed construction panel and one selected from a construction panel and a framed construction panel.

Preferably, the sealing arrangement comprises a sealing member received into a combined recess formed by adjacent recesses of adjacent panels.

Preferably, the sealing arrangement comprises a settable sealing filler composition received into a combined recess formed by adjacent recesses of adjacent panels.

According to another aspect, the invention may be said to consist in a framed roof construction comprising

a plurality of framed construction panels as claimed in any of claims 98 to 133 disposed with the framing support members of the adjacent framed construction panels abutting each other;

wherein the adjacent abutting framing support members are secured to each other by means of a securing arrangement.

Preferably, the framed roof construction comprises a plurality of framed construction panels disposed with the minor faces of adjacent wall members abutting each other.

Preferably, the securing arrangement is one or more selected from

a nut and bolt arrangement;

a clip arrangement; and

a rivet-type arrangement.

Preferably, the framed roof construction includes a mounting arrangement secured to a plurality of support members.

Preferably, the framed roof construction further comprises support battens mounted between at least two mounting arrangements.

Preferably, the framed roof construction comprises a planar drywall member mounted to the support battens.

Preferably, the framed roof construction comprises a planar drywall member mounted to the framing support members.

Preferably, the framed roof construction comprises a load bearing mounting arrangement mounted to at least one framing support member.

Preferably, the framed roof construction comprises a cladding element secured to a major face of the wall member.

Preferably, the framed roof construction includes a mounting bracket for mounting the framed roof construction to a wall.

Preferably, the cast planar wall member is moulded to resemble a plurality of roof tiles on at least one side.

Preferably, the roof construction includes a sealing arrangement between adjacent framed construction panels.

Preferably, the sealing arrangement comprises a sealing member received into a combined recess formed by adjacent recesses of adjacent panels.

Preferably, the sealing arrangement comprises a settable sealing filler composition received into a combined recess formed by adjacent recesses of adjacent panels.

According to another aspect, the invention may be said to consist in a framed wall construction comprising

a plurality of framed construction panels as claimed in any of claims 98 to 133 disposed alongside each other with the framing support members of adjacent framed construction panels abutting each other; and

wherein the adjacent abutting framing support members are secured to each other by at least one securing arrangement.

Preferably, the securing arrangement is one or more selected from

a nut and bolt arrangement;

a clip arrangement; and

a rivet-type arrangement.

Preferably, the framed wall construction comprises one selected from a framed lintel panel and a lintel panel secured along an edge of a major face of at least one framed construction panel.

Preferably, the framed wall construction comprises a plurality of framed construction panels disposed with an edge of the major faces of adjacent wall members proximate each other.

Preferably, the framed wall construction comprises a plurality of framed construction panels disposed with the minor faces of adjacent wall members abutting each other.

Preferably, the framed wall construction includes a mounting arrangement secured on at least two framing support members of adjacent framed construction panels.

Preferably, the framed wall construction further comprises support battens mounted between at least two mounting arrangements.

Preferably, the framed wall construction comprises a drywall member mounted to the support battens.

Preferably, the framed wall construction comprises a drywall member mounted to the support members.

Preferably, the framed wall construction comprises an insulative layer between the drywall member and the support members.

Preferably, the insulative layer is one or more selected from electrically insulative, and thermally insulative.

Preferably, the framed wall construction comprises a load bearing mounting arrangement mounted to at least one support member.

Preferably, the framed wall construction comprises a cladding element secured to a major face of the wall member.

Preferably, the framed wall construction comprises a pair of framed construction panels secured to each other with a major face of their wall panels abutting each other.

Preferably, the framed wall construction includes a sealing arrangement between adjacent framed construction panels.

Preferably, the sealing arrangement comprises a sealing member received into a combined recess formed by adjacent recesses of adjacent panels.

Preferably, the sealing arrangement comprises a settable sealing filler composition received into a combined recess formed by adjacent recesses of adjacent panels.

According to another aspect, the invention may be said to consist in a framed floor construction comprising

a supporting structural formation, said supporting structural formation supporting

a plurality of framed construction panels as claimed in any of claims 98 to 133, disposed alongside each other with the framing support members of adjacent framed construction panels abutting each other, and

wherein the adjacent abutting framing support members are secured to each other by at least one securing arrangement.

Preferably, the framed floor construction comprises a plurality of framed construction panels disposed with an edge of the major faces of adjacent wall members proximate each other.

Preferably, the framed floor construction comprises a plurality of framed construction panels disposed with the minor faces of adjacent wall members abutting each other.

Preferably, the plurality of framed construction panels disposed with an edge of their major faces proximate each other are secured to each other by a securing arrangement at abutting framing support members.

Preferably, securing extensions extend from proximate wall members between the wall members.

Preferably, securing extensions extend from the minor face of adjacent wall members to between the wall members.

Preferably, the securing extensions are secured to a supporting structural formation.

Preferably, the securing extensions are secured to a supporting structural formation by being cast in place in situ.

Preferably, the framed floor construction also acts as a framed roof construction for a level below the framed floor construction.

Preferably, the framed floor construction includes a mounting arrangement secured to at least two framing support members of adjacent framed construction panels.

Preferably, the framed floor construction further comprises support battens mounted between at least two mounting arrangements.

Preferably, the framed floor construction comprises a planar drywall member mounted directly or indirectly to the framing support members.

Preferably, the framed floor construction comprises a load bearing mounting arrangement mounted to the framing support member.

Preferably, the framed floor construction comprises a pair of framed construction panels secured to each other with a major face of their wall panels abutting each other.

Preferably, the framed wall construction includes a sealing arrangement between adjacent construction panels and/or adjacent construction panels and framed construction panels.

Preferably, the scaling arrangement comprises a sealing member received into a combined recess formed by adjacent recesses of adjacent panels.

Preferably, the sealing arrangement comprises a settable sealing filler composition received into a combined recess formed by adjacent recesses of adjacent panels.

According to another aspect, the invention may be said to consist in a mounting arrangement suitable for use with a construction panel as claimed in any of claims 1 to 66, said mounting arrangement comprising

a body member including at least one securing formation towards one end of the body member, said securing formation being configured and adapted for securing the body member between two adjacent support members in a stable manner,

a pair of opposed engaging formations disposed towards an opposed end of the body member from the securing formation, said engaging formations being configured and dimensioned to be suitable for engaging a batten between them.

Preferably, the body member is composed of electrically insulative material.

Preferably, the body member is composed of thermally insulative material.

Preferably, the body member is integrally formed.

Preferably, the body member may be substantially planar in configuration.

Preferably, the securing formation is a bolt hole.

Preferably, the engaging formations are a pair of opposed hook-like formations configured to engage with the edges of a batten.

According to another aspect, the invention may be said to consist in a load bearing mounting arrangement adapted and configured for use with a construction panel as claimed in any of claims 1 to 66, said mounting arrangement comprising:

a body member including

at least one securing formation towards one end of the body member, said securing formations being configured and dimensioned for rigidly securing the body member to a support member, and

an engaging formation disposed towards an opposed end of the body member from the securing formation, said engaging formations being configured and dimensioned for providing wall fixing points for one or more selected from

a wall mounted toilet;

a wall mounted cupboard

a vanity unit;

and the like.

According to another aspect, the invention may be said to consist in a cladding element adapted and configured for use with one or more selected from a construction panel as claimed in any of claims 1 to 66, and a framed construction panel as claimed in any of claims 98 to 133, wherein the cladding element comprises

a wall member defining two opposed major faces and dimensions closely aligned with the dimensions of one selected from said construction panel and a framed construction panel; and including

securing formations configured for alignment with the securing formations of said one selected from a construction panel and a framed construction panel for securing a major face of the wall member of the cladding element to a major face of the wall member of the said one selected from a construction panel and a framed construction panel, to thereby reinforce the strength of the said one selected from a construction panel and a framed construction panel, and shield the said one selected from a construction panel and a framed construction panel.

Preferably, the securing formations may be bolt holes.

Preferably, the securing formations may be recesses configured for receiving rawl bolt-type mechanisms.

Preferably, the cladding element includes a stepped edge formation suitable for creating an overlap with an adjacent similar cladding element.

Preferably, the cladding element further comprises lifting formations for lifting it.

Preferably, the wall member includes a recess along an edge adapted for operationally receiving a sealing arrangement.

According to another aspect, the invention may be said to consist in a building construction comprising at least one or more selected from a

a wall construction as claimed in any of claims 1 to 66;

a floor construction as claimed in any of claims 184 to 204;

a roof construction as claimed in any of claims 205 to 224;

a framed wall construction as claimed in any of claims 239 to 255;

a framed floor construction as claimed in any of claims 256 to 272; and

a framed roof construction as claimed in any of claims 225 to 238.

According to another aspect, the invention may be said to consist in a framed building construction comprising at least one or more selected from

a framed wall construction as claimed in any of claims 239 to 255;

a framed floor construction as claimed in any of claims 256 to 272; and

a framed roof construction as claimed in any of claims 225 to 238.

According to another aspect, the invention may be said to consist in a modular construction system comprising

one or more selected from

a construction panel as claimed in any of claims 1 to 66; and

a framed construction panel as claimed in any of claims 98 to 133; and

at least one or more selected from

a framed construction panel as claimed in any of claims 98 to 133;

a construction panel as claimed in any of claims 1 to 66;

a mounting arrangement as claimed in any of claims 273 to 279

a cladding element as claimed in any of claims 281 to 286;

a lintel panel as claimed in any of claims 67 to 97;

a framed lintel panel as claimed in any of claims 134 to 159; and

a load bearing mounting arrangement as claimed in any of claim 280.

Preferably, the modular construction system further comprises a securing mechanism for securing support members and/or framing support members to each other.

Preferably, the modular construction system further comprises at least one or more selected from:

a support batten; and

a drywall member.

Preferably, the width of the wall member is standardised for each of said construction panel; and

said framed construction panel.

Preferably, the width of the wall member is standardised for each of said construction panel;

framed construction panel;

lintel panel; and

framed lintel panel.

Preferably, the width of the wall member is standardised at between 300-700 mm.

Preferably, the width of the wall member is standardised at between 500-650 mm.

Preferably, the width of the wall member is standardised at about 600 mm.

A modular construction kit comprising at least two or more of

a wall construction as claimed in any of claims 1 to 66;

a floor construction as claimed in any of claims 184 to 204;

a roof construction as claimed in any of claims 205 to 224;

a framed wall construction as claimed in any of claims 239 to 255;

a framed floor construction as claimed in any of claims 256 to 272; and

a framed roof construction as claimed in any of claims 225 to 238.

Preferably, the width of the wall member is standardised for each of said construction panel; and

said framed construction panel.

Preferably, the width of the wall member is standardised for each of said construction panel;

framed construction panel;

lintel panel; and

framed lintel panel.

Preferably, the width of the wall member is standardised at between 300-700 mm.

Preferably, the width of the wall member is standardised at between 500-650 mm.

Preferably, the width of the wall member is standardised at about 600 mm.

For the purposes of this specification, the term “drywall member” is defined to mean a sheet of drywalling, ceiling board, floor covering or any similar sheet like or planar material of any composition.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” or “including” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” and “include” and “included” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1: shows a perspective view of a construction panel;

FIG. 2: shows a cutaway close up perspective view of the construction panel of FIG. 1

FIG. 3: shows an exploded assembly perspective view of a construction system;

FIG. 4: shows a cutaway elevation view of a building including a construction system;

FIG. 5: shows a cutaway cross section view of construction panel;

FIG. 6: shows a cutaway plan view of a framed wall construction;

FIG. 7: shows a side view of a support member;

FIG. 8: shows a cutaway plan view of a framed roof construction;

FIG. 9: shows a cutaway cross section side view of a lintel panel and mounting arrangement in a wall construction;

FIG. 10: shows a cutaway side view of a load bearing mounting arrangement lintel panel in a wall construction;

FIG. 11: shows a cutaway plan view of a wall construction;

FIG. 12: shows a cutaway cross section view of a wall construction;

FIG. 13: shows a cutaway cross section plan view of an internal corner created by a framed wall construction;

FIG. 14: shows a cutaway cross section plan view of a panel join, an external corner, an internal partition join, and a stop end created by a construction system;

FIG. 15: shows a cutaway cross section plan view of a stop end created by a construction system;

FIG. 16: shows a cutaway cross section plan view of an external corner in a wall construction;

FIG. 17: shows a cutaway cross section plan view of a lintel panel;

FIG. 18: shows a cutaway cross section plan view of a wall construction;

FIG. 19: shows a cutaway cross section plan view of a framed wall construction;

FIG. 20: shows a cutaway cross section plan view of a wall construction showing an external corner;

FIG. 21: shows a cutaway cross section elevation view of a wall construction showing how the height of the wall construction can be extended by including a lintel panel;

FIG. 22: shows a cutaway cross section elevation view of a framed wall construction, a framed floor construction and a wall construction;

FIG. 23: shows a cutaway cross section elevation view of a framed wall construction, a framed floor construction and a wall construction;

FIG. 24: shows a cutaway cross section elevation view of a framed wall construction;

FIG. 25: shows a cutaway cross section elevation view of a framed wall construction;

FIG. 26: shows a cutaway plan view of a framed wall construction with the framed construction panels bolted to each other back to back;

FIG. 27: shows a cutaway plan view of a floor construction;

FIG. 28: shows a cutaway cross section elevation view of a framed wall construction, a floor construction and a wall construction;

FIGS. 29-31: shows how internal and external corners may be created by various configurations of frame construction panels and construction panels;

FIG. 32: shows a cutaway cross section elevation view of a lintel panel used to form a parapet, supported on a construction panel;

FIG. 33: shows a cutaway cross section elevation view of a lintel panel used under a low set window;

FIG. 34: shows a cutaway elevation view of a wall construction;

FIG. 35: shows a plan view of a lintel panel secured to a framed construction panel;

FIG. 36: shows a cutaway cross section elevation view of a lintel panel secured to a structural member to form a window sill;

FIG. 37: shows a cutaway cross section elevation view of a framed floor construction and a wall construction;

FIG. 38: shows a perspective view of a wall construction secured to a framed wall construction showing the interior major faces;

FIG. 39: shows a variety of panels that are available for use in the modular construction system;

FIG. 40: shows a cutaway cross sectional view of a heating arrangement integrally formed into one of the panels;

FIG. 41: shows a cutaway side view of a heating arrangement integrally formed into a panel;

FIG. 42: shows a close up cutaway cross sectional view of a heating arrangement integrally formed into a panel, showing a connection made to the piping;

FIG. 43: shows a cutaway top view of an insulative polystyrene layer mounted between dry walling and a support member of a construction panel;

FIG. 44: shows a sealing arrangement for sealing between two construction panels;

FIGS. 45-55: shows a series of architectural sketches showing various configurations of constructions that may be built using the modular construction system; and

FIG. 56: shows a cutaway cross section view of a wall construction mounted on a supporting structural formation;

FIG. 57: shows a plan view of a framed roof construction;

FIG. 58: shows an elevation view of a roof construction;

FIG. 59: shows a cutaway elevation view of a roof construction;

FIG. 60: shows a close up cutaway elevation view of a roof construction;

FIG. 61: shows a cutaway cross section view of a wall construction mounted on a supporting structural formation;

FIG. 62: shows an elevation view of the supporting structural formation of FIG. 61 showing a vent hole;

FIG. 63: shows a plan view of a first embodiment of a sealing arrangement between two wall members; and

FIG. 64: shows a plan view of a second embodiment of a sealing arrangement between two wall members.

### DETAILED DESCRIPTION OF THE PREFERRED EMBODIMENT(S)

With reference to the above drawings, in which similar features are generally indicated by similar numerals, a modular construction system according to one aspect of the invention is generally indicated by the numeral 100. The construction system 100 is generally comprised of a construction panel 200, a lintel panel 300, a mounting arrangement 400, a cladding element 500, a load bearing mounting arrangement 600, a framed construction panel 1200, and a framed lintel panel 1300.

The modular construction system 100 may be used to construct various configurations of floor constructions 700, wall constructions 800, roof constructions 900, framed floor constructions 1700, framed wall constructions 1800, and framed roof constructions 1900 to form a building 1000.

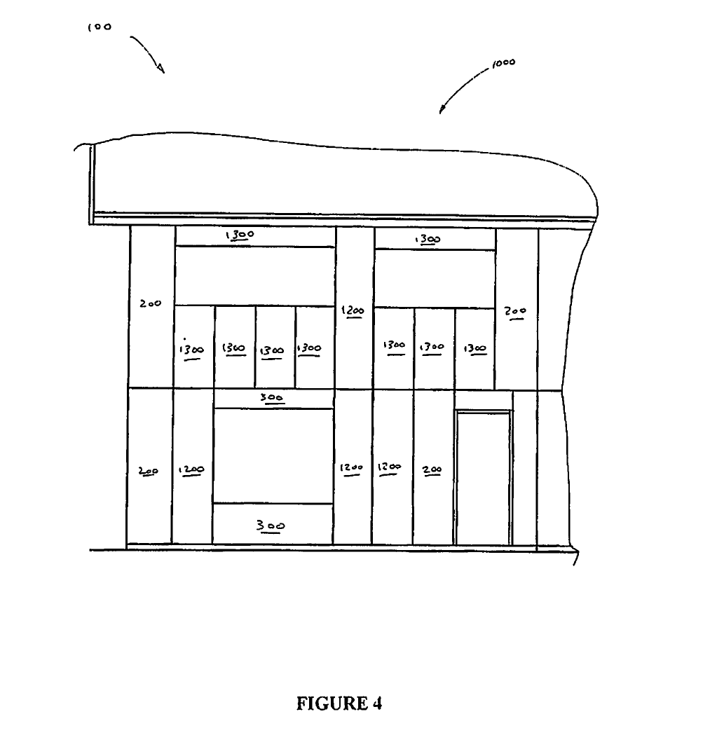

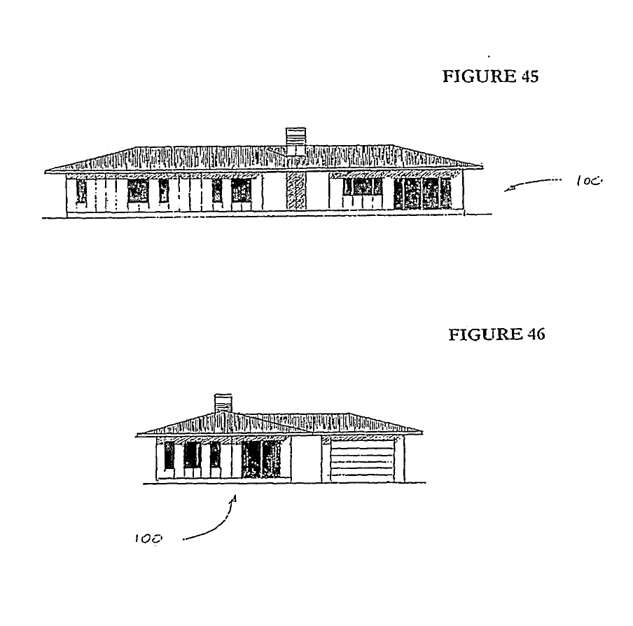

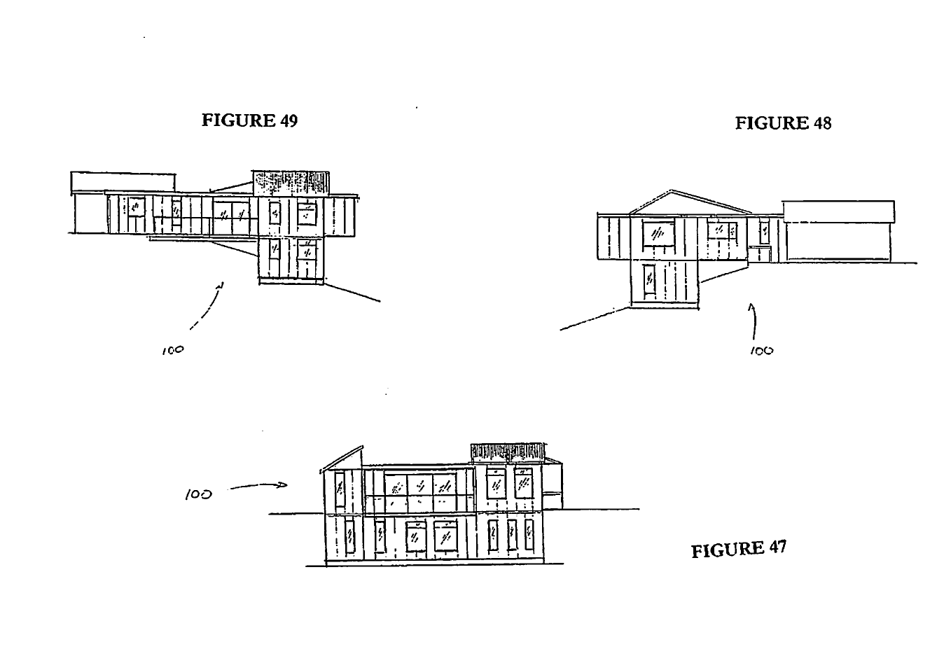

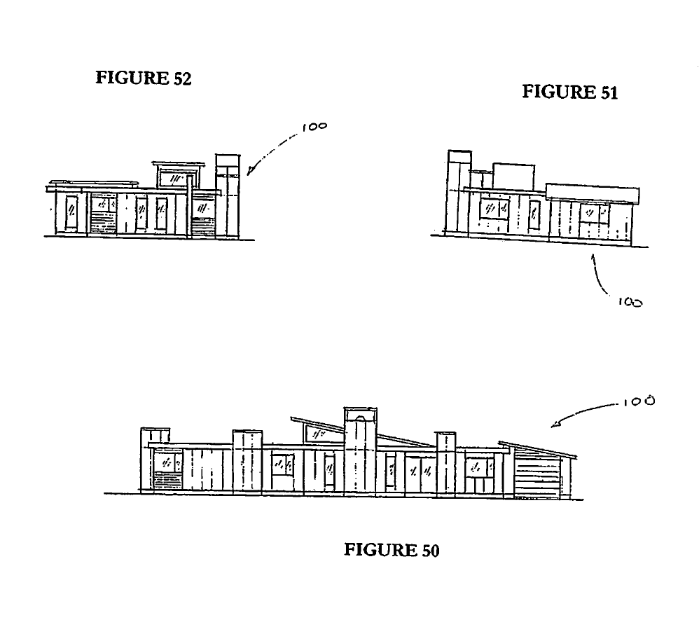

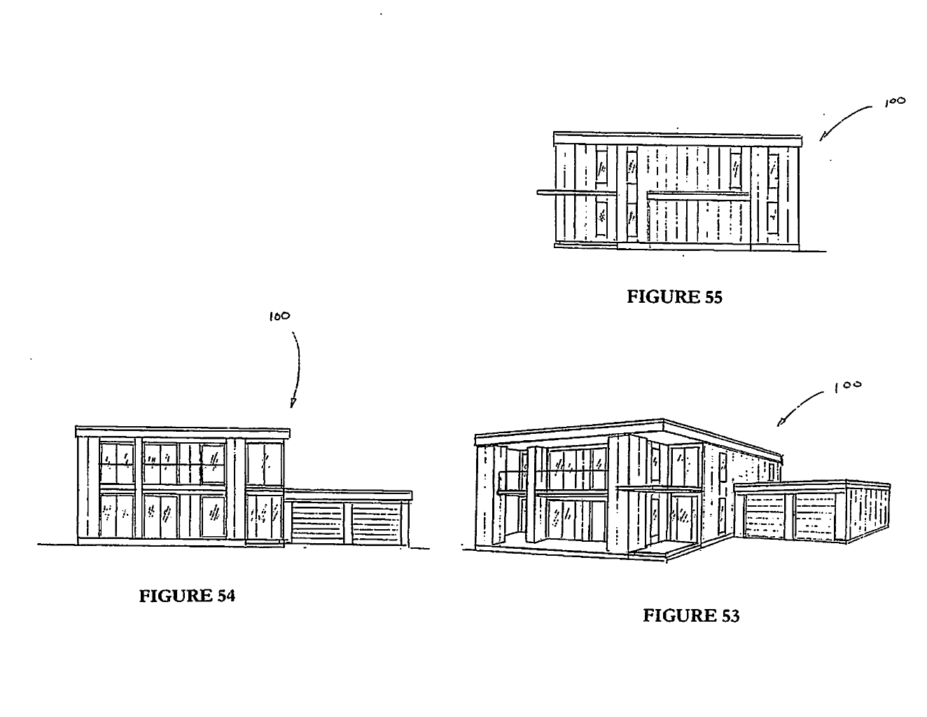

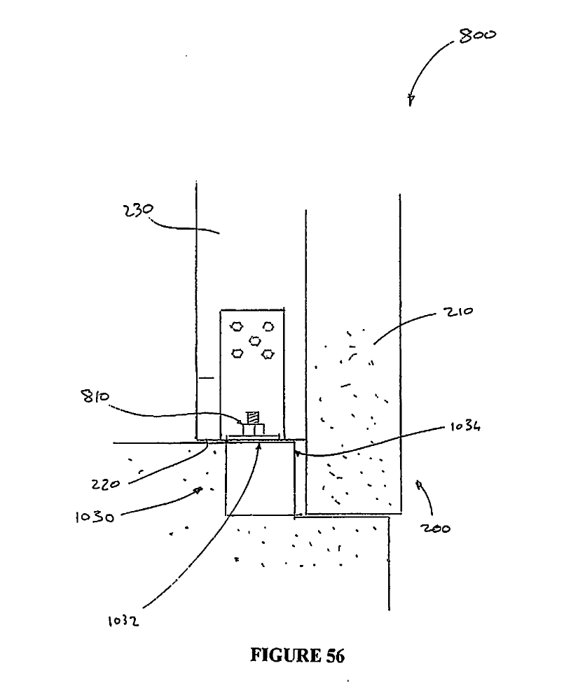

It is envisaged that the modular nature of the construction system 100 will allow a wide variety of configurations of buildings 1000 to be constructed, allowing relatively wide architectural freedom to design, while providing a relatively cheap, quick way of assembling buildings 1000 which have reasonable fire resistance, heat insulation, sound insulation, earthquake resistance, and ease of assembly. It is further envisaged that a building 1000 (as shown in FIGS. 4 and 45 to 53) built from the components may not require any specialised skills, nor large machinery to assist with the erection of the building 1000.

The construction panel 200 comprises a cast concrete or cement planar wall member 210 defining two opposed major faces 215; and at least one, but preferably more support members 220 partially embedded in the wall member 210. The defining feature of the support members 220 is their location. In particular, a support member 220 as used in this specification is located to extend from a major face 215 of a wall member 210 at a distance “d” (as shown in FIG. 2) from at least one of the edges of the wall member 210. In this way, an unimpeded extended portion 212 of the wall member 210 is defined by the extension of the wall member 210 outwardly from the support member substantially along the plane of the wall member 210.

A support member 220 is differentiated in this regard from a “framing support member” 230 as used in this specification, in that the framing support member 230 is disposed to extend from the major face 215 of the wall member 210 proximate an edge of the wall member.

Similarly, a construction panel 200 and a lintel panel 300 include at least one extended portion 212 and 312 respectively along at least one of the edges of their major faces.

Wherever the term “framed” or “framing” is used in this description, this indicates that the panel being referred to does not include such an extended portion 212 or 312. In such “framed” panels, a framing support member 230 is used to extend from the major face 215 of the wall member 210 proximate its edge. A construction panel 200 can have a combination of support members 220 and framing support members 230, as long as at least one extended portion 212 is presented. A framed construction panel does not include a support member 220, but can have one or more framing support members 230 proximate its edge. If only one framing support members 230 is present along an edge of a major face, this shall not be construed as defining an extended portion toward the opposite edge of the major face.

Also, for purposes of clarity, when a larger construction is referred to as being “framed”, this indicates that none of its component panels includes such an extended portion 212 or 312. However, when at least one of the panels making up such a larger construction includes such an extended portion, then the construction and/or panel is not referred to as being “framed’.

The support members 220 and/or framing support members 230 can be preferably L-shaped, C-shaped or channel shaped in cross section, but can be of any suitable cross sectional shape. Further in one embodiment, the support members 220 are composed of a metal, preferably steel, composition, however in another embodiment the support members 220 can be composed of a fibrous composition such as glass fibre, carbon fibre or the like. In one preferred embodiment, the support members 220 could be composed of pressed galvanised steel plate between 0.2 to 1.5 mm, and preferably about 0.5 mm thick, and formed as a channel section. It is envisaged that in another embodiment the support members 220 can be composed of a pultruded fibre composition.

The support members 220 are locate nearby, but not at the edge of, at least one edge of the wall member 210. The support members 210 and/or framing support members 230 preferably extend from one major face 215 of the wall member, although it is envisaged that they could extend from both major faces. The major face 215 of the wall member 210 that the support members 220 and/or framing support members 230 extend from, will typically be the inside face of the construction panel—i.e. facing inwardly in a completed building—although this may not always be the case.

The effect of the structure of the construction panel 200 described above is that of a single wall member 210 having at least one unimpeded edge, with at least one partially embedded support member 220 extending from the major face 215 of the wall member at a distance d (shown in FIG. 2) from one of the edges of the wall member 210.

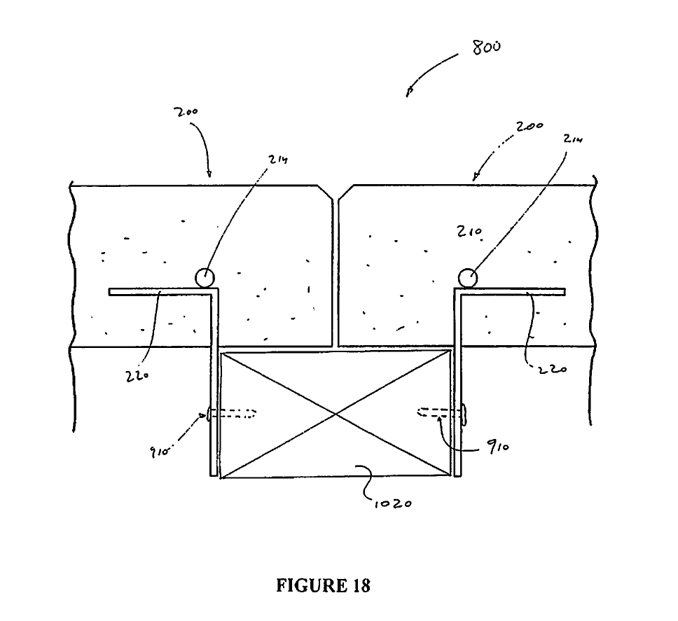

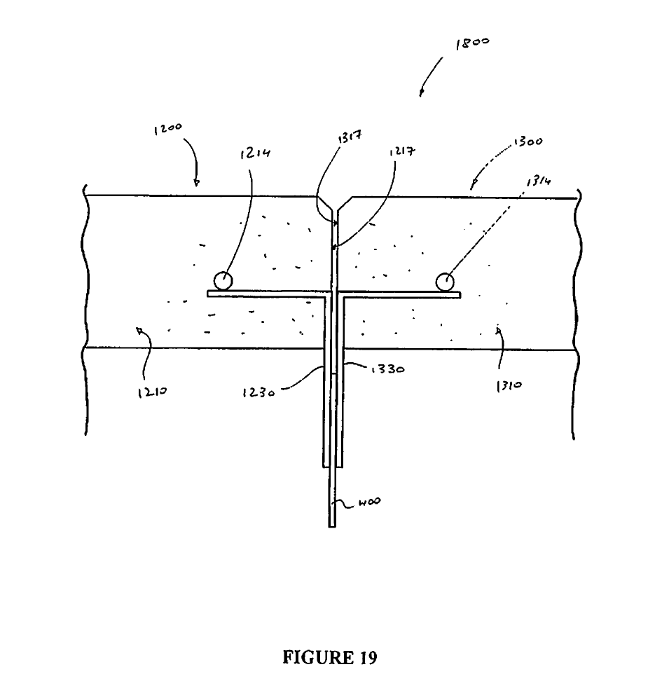

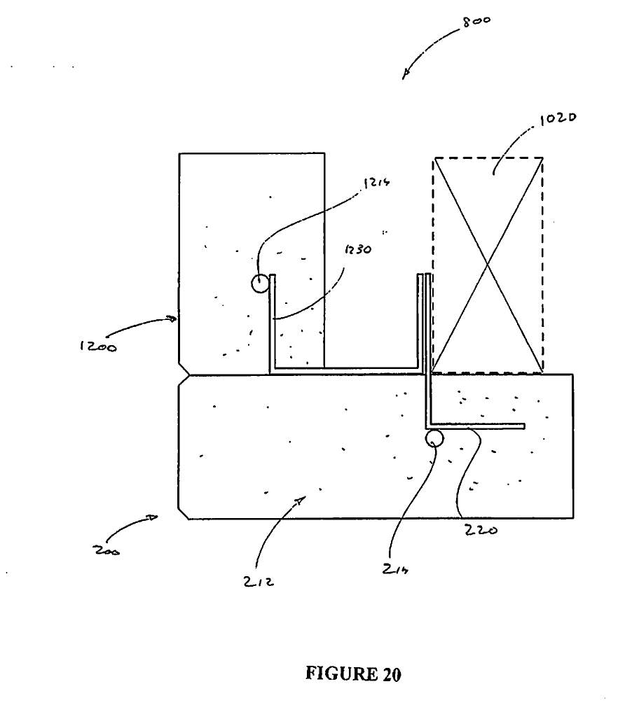

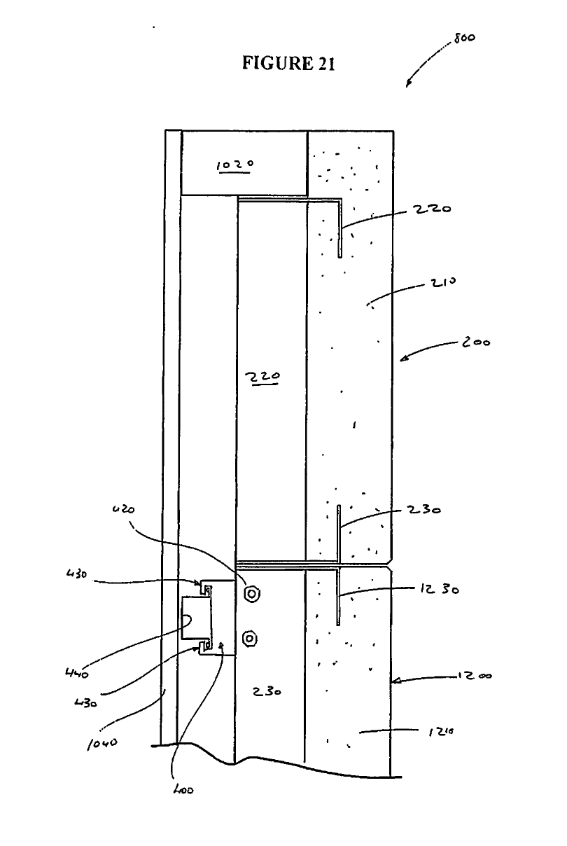

In a preferred embodiment, at least one of the outer edges of the extended portion 212 are unimpeded, allowing the extended portion to be snugly abutted against an extended portion of a similar construction panel 200, while the support members 220 of the adjacent construction panels will sit on either side of a suitably dimensioned structural member 1020 of a building 1000 (as shown in FIG. 18), such as a post, rafter, joist, or the like. The major face 215 of the wall member 210 which does not have support members 220 and/or framing support members 230 extending from it will present a clean, preferably cement, surface—typically facing towards the outside of the building 1000—which may be painted or clad in a cladding element 500 as described below.

In a preferred embodiment, the support member 220 extends from one major face 215 of the wall member 210 at a distance of between 10-200 mm from the edge of the major face, and more preferably at a distance of between 30-150 mm from the edge of the major face. In a most preferred embodiment, the support member 220 extends from a major face 215 of the wall member 210 at a distance of about 45 mm or about 55 mm from the edge of the major face 215. In another most preferred embodiment, the support member 220 extends from a major face 215 of the wall member 210 at a distance of about 135 mm from the edge of the major face 215.

It is envisaged that the construction panel 200 will be substantially rectangular in shape, and can include a support member 220 extending from a major face 215 of the wall member 210 around all four of its edges, although this need not necessarily be the case. In some embodiments, the support member 220 can extend from the major face of the wall member 210 around 1, 2, or 3 of its edges.

It is further envisaged that the construction panel 200 can include a framing support member 230 which extends along an edges of the major face of the wall member 210 that the support members 220 do not extend along. The framing support members 230 can typically be disposed to extend from the same major face 215 of the wall member 210 that the support member(s) 220 extend from, although this may not always be the case, depending on the design of the larger construction.

It is envisaged that the construction panels 200 will be manufactured off site as pre-cast (preferably concrete or cement) construction panels 200 in a wide variety of configurations. Stock may be held of each type of configuration of construction panel 200, and the correct configuration of construction panel 200 selected from the held stock and sent to site according to the design of the building 1000 to be built.

Typically, a construction panel 200 having a support member 220 disposed towards one edge would be used where the edge of the wall member 210 of the construction panel is intended to be secured to a suitably dimensioned structural member (as shown in FIG. 18). The distance between the unimpeded edge of the extended portion 212 and the support member 220 allows the support member 220 to be secured to a structural member 1020, while the extended portion extends past the structural member 1020 to present a clean surface towards the outside of the structural member 1020.

It is envisaged that in a construction panel, the plurality of support members 220 and/or the framing support members 230 will be connected to each other in a secured manner, such as by welding, riveting or bolting, in order to increase the structural strength of the construction panel 200.

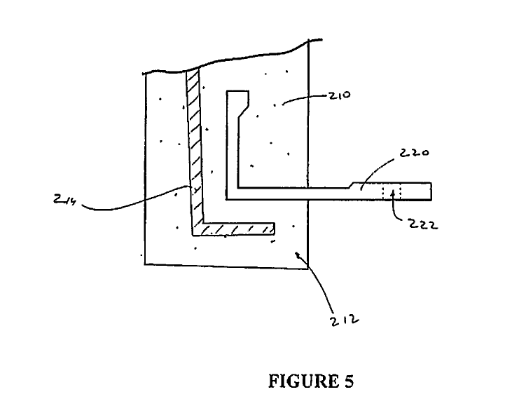

Further, the wall member 210 can include internal reinforcing inserts 214 shown in FIG. 5 in the form of metal (preferably steel) reinforcing bar (“rebar”) or mesh which extend from the wall member 210 into the extended portion 212. In another embodiment, the wall member 210 and the extended portion 212 can each have their own reinforcing inserts 214. In one embodiment, the reinforcing inserts 216 can be steel mesh. However, it is envisaged that the reinforcing inserts could also be composed of a fibrous composition, such as glass fibre, carbon fibre or the like. In another embodiment, it is envisaged that the reinforcing inserts 214 can be pre-stressed.

In one embodiment of the construction panel 200, the reinforcing inserts 214 extend from the wall member as securing extensions 216. The use of the securing extensions 216 will be explained below.

In one embodiment of the construction panel, a support member 220 extends along one edge of the wall member, and one selected from a support member 220 and a framing support member 1230 extends along an opposed edge of the wall member 210. In this embodiment, the inside distance between the support member 220 the opposed support member 220 or framing support member 1230 is between 300 mm and 900 mm, and most preferably around 500 mm.

In a preferred embodiment, it is envisaged that the width of the wall member 210 will coincide with the usage of multiples of 300 mm (or approximately one imperial foot) for materials in the construction industry. For example, the most popular width is 1200 mm for exterior and interior linings. Further, a width of over 600 mm for attachment studs does not comply with (New Zealand) building regulations, and the use of widths of less than 600 mm may not be economical.

In a most preferred embodiment of the construction panel 200, the width of the wall member 210 will be standardised at 600 mm. This may allow increased architectural freedom of design, and reduced complexity in the number of and design of construction panels 200.

Further it is envisaged that in a preferred embodiment, the wall member 220 will have a length of about 2.5 meters long, (commensurate with the wall height of a typical residential building). The thickness of the wall member is envisaged as being about 50 mm thick. This thickness is expected to provide structural integrity to the outer wall of the building 1000, as well as fire resistance, damage resistance, security and thermal insulation.

The use of a construction panel 200 having a wall member width of about 600 mm, at a thickness of about 50 mm, and having a height commensurate with typical residential buildings 9 at between 2-3 m), should result in a construction panel 200 having a typical weight of around 200-300 kilograms, and preferably around 250 kilograms.

It is envisaged that this weight could be relatively manually handled by a small team of around 2-5 construction workers, or handled with the assistance of a small crane-type mechanism, without the requirement of a large lifting mechanism such as a forklift or the like. It is envisaged that any of the panels described could include lifting formations (not shown), such as a hook or aperture to assist in lifting the panels by a crane or forklift type mechanism. These lifting formations would preferably be associated with the support members 220 or framing support members 230.

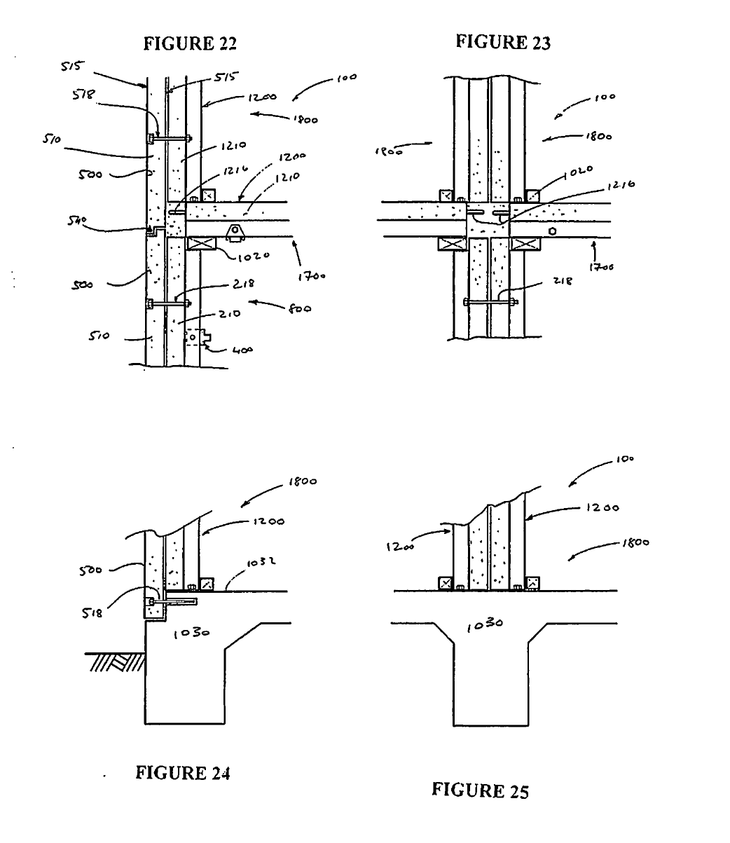

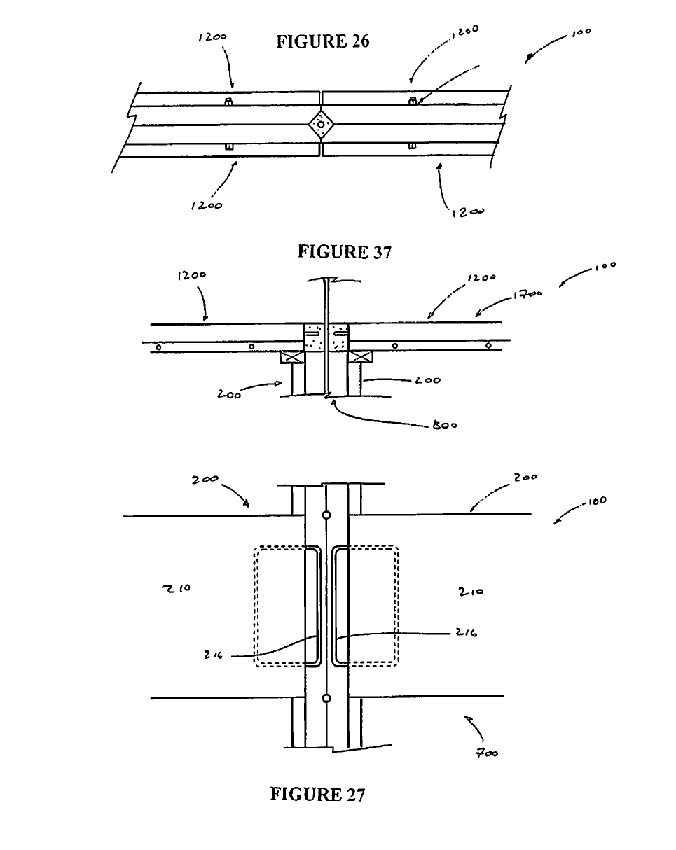

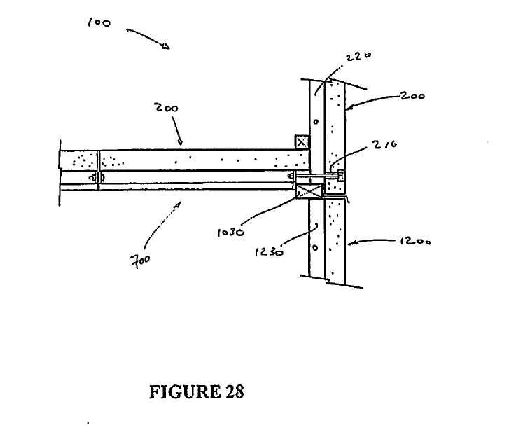

In yet another embodiment shown in FIGS. 22 and 23, the construction panel includes securing formations 218 in the form of apertures for bolts extending through the wall member 210. In another embodiment the securing formations 218 may be recesses or any other formation. These securing formations 218 are for allowing cladding elements 500 to be secured to the outer major face of the wall panel 210 as described below.

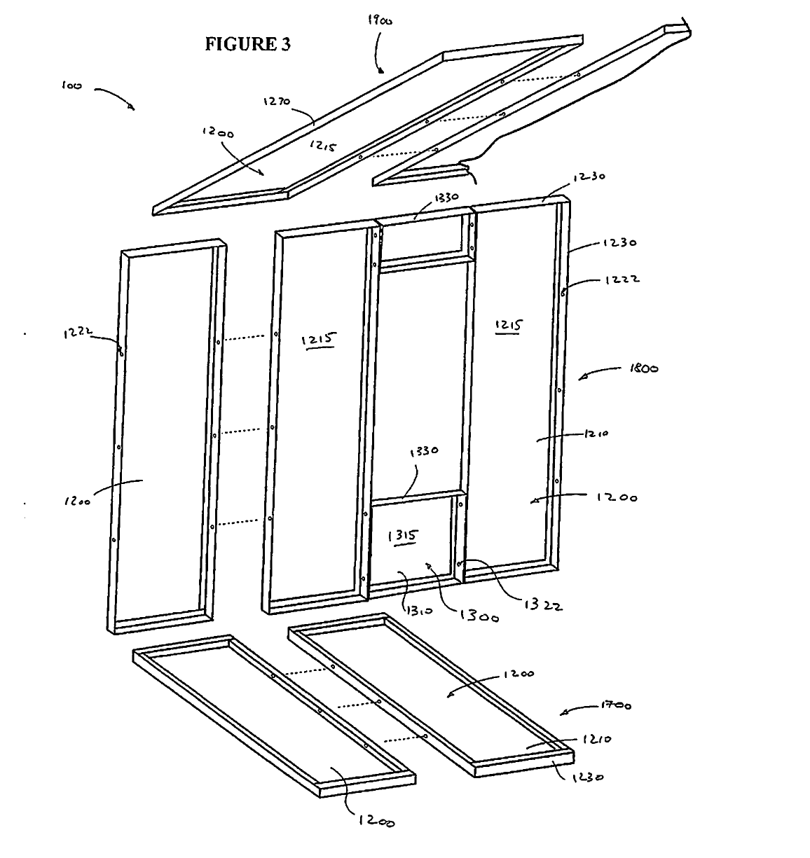

The framed construction panel 1200 (as shown in FIG. 3) comprises a cast planar wall member 1210 defining two opposed major faces 1215; and a pair of partially embedded framing support members extending from one major face 1215 of the wall member 1210 proximate opposed edges of the wall member 1210.

For the purposes of clarity, features of the framed construction panel 1200 that are similar to the construction panel 200 are numbered similarly, but have an additional number 1 inserted. However, as explained before, a framed construction panel 1200 does not include any support members 220.

In one embodiment, the inside distance between the framing support members 1230 can be standardised at between 300 mm and 900 mm, and more preferably between 500-700, and most preferably around 600 mm.

However, in a most preferred embodiment of the construction panel 1200, the width of the wall member 1210 will be standardised at 600 mm. This may allow increased architectural freedom of design, and reduced complexity in the number of and design of construction panels 1200. This width also allows for increased manageability in installation (as will be described below), as well as reduced weight for increased ease of delivery and installation.

The length of a the wall members for the construction panels and/or framed construction panels could change depending on whether the construction panel and/or framed construction panels are for use in a wall or roof or floor construction.

In a preferred embodiment, the wall member 1210 is also between 1.5 and 3.5 meters long, and most preferably about 2.5 m.

In an even further preferred embodiment, the wall member 1210 has a thickness of between 30-100 mm, and most preferably about 55 mm.

It is envisaged that the wall member 1210 of the framed construction panel 1200 will include internal reinforcing inserts 1214 similar to that of the wall member 1210 of the construction panel 200. These reinforcing inserts 1214 can also extend from the wall member as securing extensions 1216.

The framed construction panel 1200 is expected to be similar to the construction panel 200 in all respects such as material, structure and dimensions, except that it does not include an extended portion 212, but instead the framing support members 120 extend from the major face 1215 of the wall member 1210 at or proximate the edge of the major face 1215. The reason for this will be explained below.

In one embodiment, the framed construction panel 1200 can also include securing formations 1218 for allowing cladding elements 500 to be secured to at least one major face (preferably the outer face) of the wall panel 1210.

Further, the modular construction system 100 comprises a lintel panel 300 and a framed lintel panel 1300. For the purposes of clarity, features of the lintel panel 300 that are similar to that of the construction panel 200 are referenced with similar numerals, but having the prefix “3” instead of “2”. Features of the framed lintel panel 1300 that are similar to that of the framed construction panel 1200 are referenced with similar numerals, but having the prefix “13” instead of “12”.

The lintel panel 300 and/or framed lintel panel 1300 is envisaged for use to extend along the floor line of the construction below a window opening, or along the roof line of a construction above a window opening.

The lintel panel 300 is envisaged to be similar in construction to the construction panel 200, in that it comprises a cast planar wall member 310 defining two opposed major faces 315, and at least one partially embedded support member 320 extending from one major face 315 of the wall member 310 proximate an edge of the wall member 310, and wherein the wall member 310 extends outwardly along the plane of the wall member 310 from the support member 320 to define an extended portion 312.

The difference between the construction panel 200 and the lintel panel 300 is that the wall member 310 has a length of approximately one tenth to two thirds of the typical length of a construction panel 200 or framed construction panel 1200, to enable the lintel panel 300 to be secured adjacent one of the construction panel 200 or the framed construction panel 1200 to present an opening in a wall construction suitable for insertion of a window.

It is envisaged that the width of the lintel panel 300 and framed lintel panels 1300 from top to bottom (i.e. once installed) will be about 300 mm, but could be about 600 mm. It is further envisaged that the length of the lintel panel 300 will vary from 600 mm to about 3000 mm to comply with regulations. In order to span over large distances (e.g for larger windows), the lintel panel 300 can include pre-stressed reinforcing inserts 314. It is envisaged that the lintel panel 300 can be used alongside the foot and the top of an adjacent construction panel or framed construction panel, to present an opening in the wall construction formed by the lintel panels 300 and construction panels 200 (or framed construction panels 1200) to present an opening towards the central region or middle of the construction panel 200 (as shown in FIGS. 3 and 4).

It is envisaged that the lintel panel 300 may otherwise be similar to the construction panel 200 in respect of materials used, and the inclusion of reinforcing inserts 314, securing extensions 316 which extend from a minor face 315 of the wall member 310 and securing formations 318 to which a suitably dimensioned cladding element may be secured.

In a preferred embodiment the lintel panel 300 will be rectangular or square in shape. Further, the lintel panel 300 can include support members 320 extending around all of its edges, or only one, and can have framing support members 30 extending along any of the remaining edges. The lintek panel can also include framing support members 330 extending along any edges that are not associated with support members 320.

It is envisaged that the inside distance between a support member 320 disposed along one edge of the major face 315 of the wall member 310, and a support member 320 or framing support member 330 extending along an opposed edge across the width of the lintel panel will be between 300 and 900 mm and most preferably 600 mm.

The features described in the lintel panel 300 are mirrored in the framed lintel panel 1300, except that the framed lintel panel 1300 by definition does not include any support member defining an extended portion 312.

A framed lintel panel 1300 according to the invention is similar in many respects to the framed construction panel 1200 in that it comprises a cast planar wall member 1310 defining two opposed major faces 1315, with a pair of partially embedded framing support members 1330 extending from one major face 1315 of the wall member 1310 proximate opposed edges of the wall member 1310. The inside distance between the framing support members 1330 is between 300 mm and 900 mm, and most preferably 600 mm. Alternatively, the width of the wall member 1310 is 600 mm to allow for modular design and/or construction.

The framed lintel panel 1300 differs from the framed construction panel 1200 in that the wall member 1310 has a length of approximately one tenth to two thirds of the framed construction panel 1200 or the construction panel 200. It is envisaged that the width of the lintel panel 300 and framed lintel panels 1300 from top to bottom (i.e. once installed) will be about 300 mm, but could be about 600 mm. This enables the framed lintel panel 1300 to be secured adjacent a construction panel 200 or framed construction panel 1200 to present an opening in the wall construction formed by the framed lintel panel 1300 and adjacent construction panels 200 (or framed construction panels 1200) suitable for a window.

It is envisaged that the framed lintel panel 1300 will be similar to the lintel panel 300 in many respects, such as wall member dimensions, and the inclusion of reinforcing inserts 1314, securing extensions 1316 and securing formations 1318. However, the framed lintel panel 1300 has only framing support members 1330 extending around at least one of the edges of a major face 315 (preferably an inside major face) of its wall member 1310, and no support members.

It is also envisaged that support members 220, 320 (where applicable) and/or framing support members 230, 330 1230, 1330 could extend only partially around any edge of the construction panels 200, lintel panels 300, framed construction panels 1200 or framed lintel panels 1300.

It is envisaged that the support members 220, 320 (where applicable) and framing support members 230, 330 1230, 1330 (“the support members”) of the construction panel 200, lintel panel 300, framed construction panel 1200 and framed lintel panel 1300 (“the panels”) respectively, will each have batten support formations 222, 322, 1232, 1332 (“the batten support formations’) in the form of holes or slots for supporting support battens 440 on an interior surface of their wall members. The battens can then be used for supporting the mounting of drywall members 1040 for purposes of providing an interior surface (i.e. drywalling).

It will be appreciated that the batten support formations 222, 322, 1232, 1332 need not necessarily support battens 440 directly, but can do so through an intermediate formation such as a mounting clip 400 as is preferred. It is envisaged that the batten support formations 222, 322, 1232, 1332 of each of the support members 230, 330 1230, 1330 will be configured and dimensioned to be in alignment with each other when the panels 200, 300, 1200, 1300 are secured to each other as part of a floor construction 700, wall construction 800, or roof construction 900.

In an alternative embodiment, a drywall member 1040 can be directly mounted to the support members. In a more preferred embodiment, the wall construction can comprise an insulative layer 450, such as a polystyrene or similar layer, between the drywall member 1040 and the support members as shown in FIG. 43.

Preferably, the framing support members include similar batten support formations for supporting support battens.

The dimensions and corresponding weight of the construction panels 200, framed construction panels 1200, lintel panels 300 and framed lintel panels 1300 (“the panels”), allows the panels to be directly installed in position with a retaining nut and bolt arrangement as the panels are offloaded from a light delivery vehicle, using the light cranes typically found installed on the back of such light delivery vehicles.

In the applicant's experience in constructing prototype residential buildings, the panels could be installed to form wall constructions 800 as fast as they were offloaded from the delivery vehicle, if the structural members 1020 (i.e. skeleton) and supporting structural formation 1030 (i.e. foundation) of the construction were already in place. This ease of installation resulted in the walls of a residential house being assembleable in a day. Further, since the dimensions of each of the panels are manageable, this allows for construction in areas with restricted space (where, for example, large wall sections would not be manoeuvrable)

Further provided by the construction system 100 is a cladding element 500 for use with one or more selected from a construction panel 200 or framed construction panel 1200 as described. The cladding element 500 comprises a wall member 510 defining two opposed major faces 515 and having a height and width closely aligned with the dimensions of the panels.

The cladding element also includes securing formations 518 configured for alignment with the securing formations 218, 1218, 318, 1318 (“the securing formations”) of at least one of the panels 200, 300, 1200, 1300. The securing formations of the cladding element 500 are for securing a major face 515 of the wall member 510 of the cladding element 500 to a major face of the wall member of one of the panels.

It is envisaged that the securing of a cladding element 500 to the outside of one of the panels 200, 1200, 300, 1300 will reinforce the strength of the panels. It will also serve to shield the panels from weather, and can also provide ornamentation of the building 1000. In a preferred embodiment, the securing formations 518 are be bolt holes, but they could also be recesses for rawl bolt type securing mechanisms, or any other suitable formation. A further preferable feature of the cladding element 500 are stepped edge formations 540 at opposed ends of the cladding elements, and most preferably at those ends aligned operationally with the top and bottom of the cladding element 500. The stepped edge formation 540 is configured and dimensioned to overlap with a stepped edge formations 540 of an adjacent similar cladding element 500 (as shown in FIG. 22). This overlap will assist in weatherproofing the building 1000.

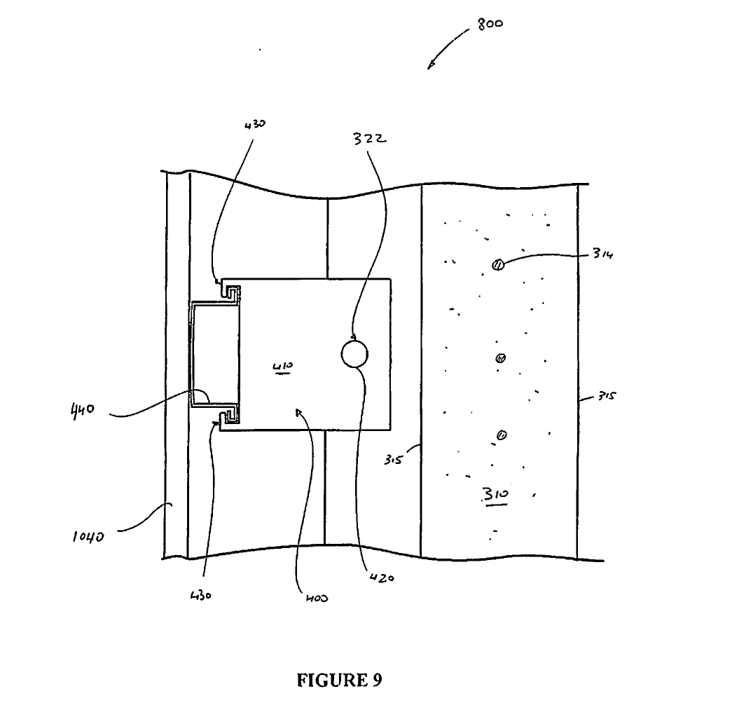

Further provided in the modular construction system is a mounting arrangement 400 (as shown in FIG. 9), suitable for use with at least one of the panels 200, 300, 1200, 1300. The mounting arrangement 400 comprises a substantially planar non-conductive body member 410. The body member 410 defines a pair of securing formations 420 disposed towards one end of the body member 410. These securing formations 420 are suitable for securing the body member 410 between two adjacent support members 220, 320 (the support members”) or framing support members 230, 1230, 330, 1330 (“the framing support members”) of one of the panels in a stable manner. In a preferred embodiment, the securing formations 420 are bolt holes, but could be specially shaped holes or slots (not shown). The body member 410 further includes a pair of opposed engaging formations 430 in the form of opposed hook formations disposed towards an opposed end of the body member 410 from the securing formations 420. The engaging formations 430 are configured and dimensioned to be suitable for engaging a support batten 440 (such as a commonly used “Rondo batten”) between them.

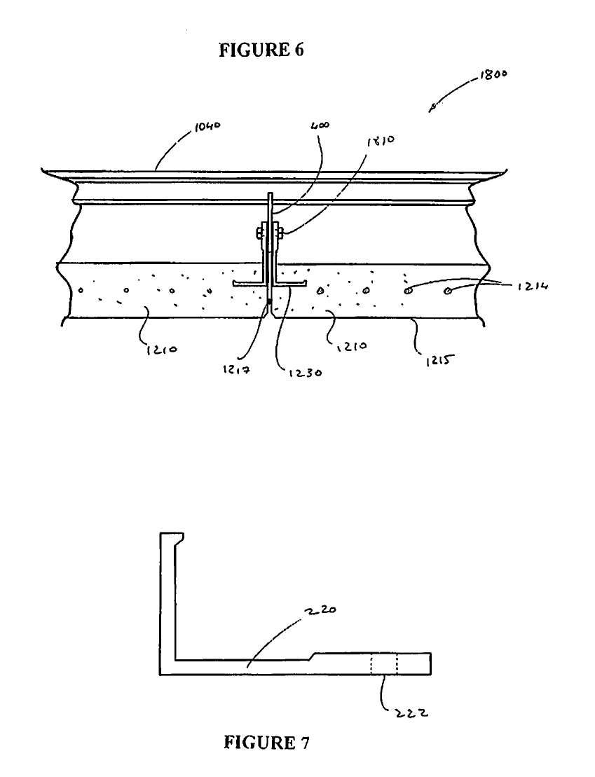

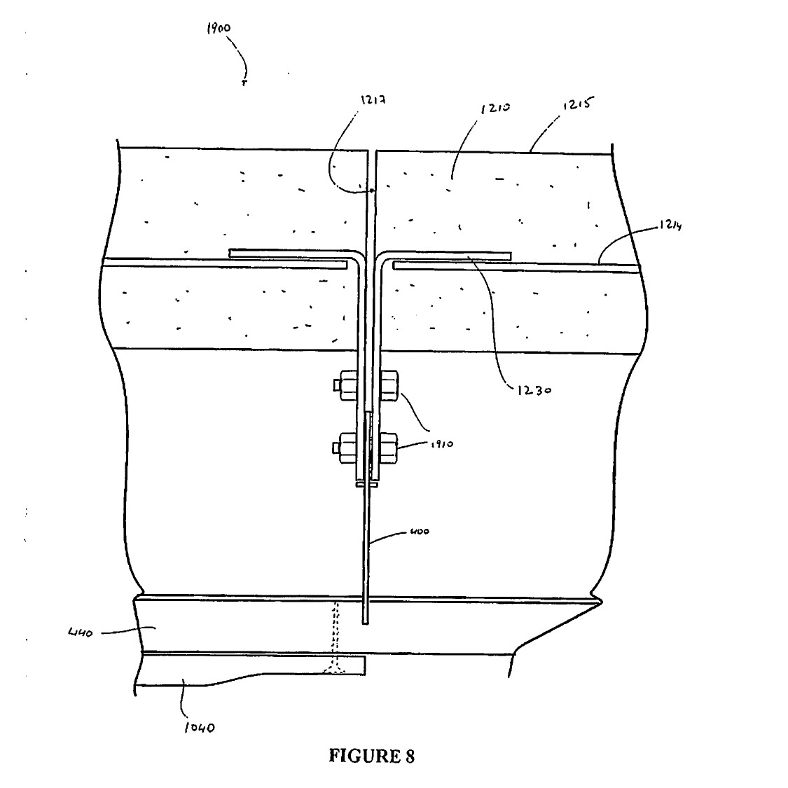

In a most preferred embodiment, the body member 410 is composed of an integrally formed plastic material, preferably moulded in an injection moulding process or the like. It is envisaged that the planar body member will be inserted between adjacent framing support members 230, 330, 1230, 1330 (as shown in FIG. 6). This will provide a thermally and/or electrically insulative barrier between the framing support members 230, 330, 1230, 1330.

Further provided in the modular construction system is a load bearing mounting arrangement 600 for enabling the mounting of heavier items off the panels 200, 300, 1200, 1300.

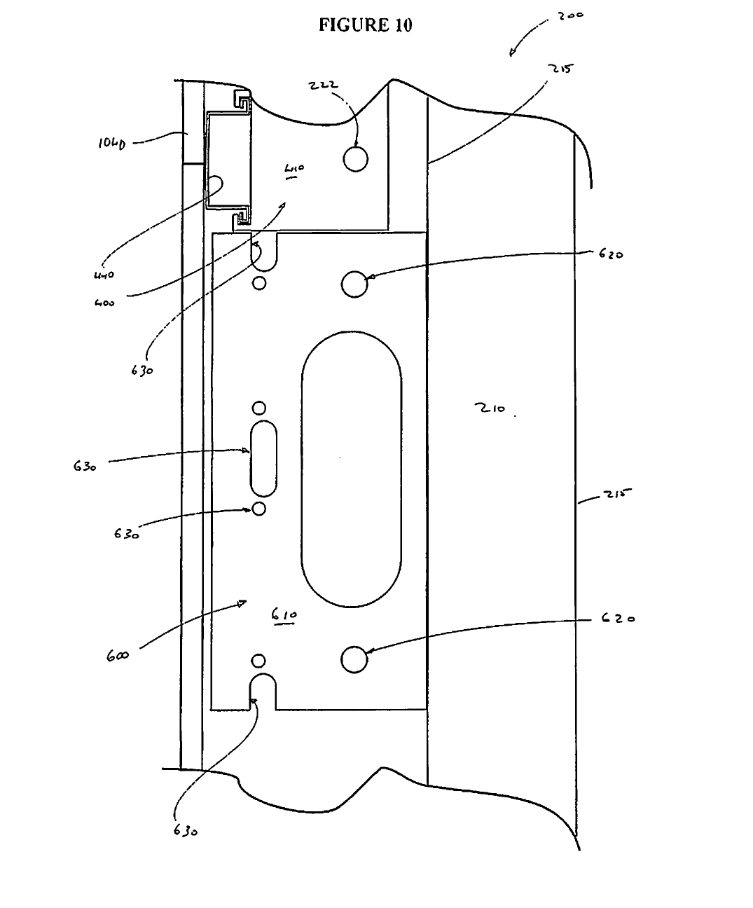

The load bearing mounting arrangement 600 comprises a strengthened body member 610 including a pair of securing formations 620, in the form of holes for bolts (as shown in FIG. 10), towards one end of the body member 610. The securing formations 620 are configured and dimensioned for rigidly securing the body member 610 to a support member 220, 320 or framing support member 230, 330, 1230, 1330. The body member 610 further defines an pair of opposed engaging formations 630 disposed towards an opposed end of the body member 610 from the securing formations 620, said engaging formations 630 being configured and dimensioned for providing wall fixing points for one or more selected from a wall mounted toilet; a wall mounted cupboard; a vanity unit; or the like.

It is envisaged that the construction panel 200, the framed construction panel 1200, the lintel panel 300 and the framed lintel panel 1300 described above can be used in a wide variety of configurations which complement each other. Particular configurations of these are now described generally as various types of “constructions”. However, it should be appreciated that any number and type of constructions as described below can be used in the assembly of a building 1000.

According to another aspect of the invention, a wall construction 800 is provided (as shown in FIG. 11). The wall construction 800 comprises a plurality of construction panels 200 disposed with the edges of the major faces 215 of adjacent planar wall members 210 abutting each other, with a structural member 1020 of a building 1000 disposed intermediate the support members 220 most proximate the abutting edges of the adjacent wall members 210. The construction panels 200 are secured to the structural member 1020 by at least one securing arrangement 810. The securing arrangement 810 can be a nut and bolt type securing arrangement, or a nail-type securing arrangement, a rivet type securing arrangement, or any other suitable securing arrangement. The wall construction 800 can further comprise a construction panel 200, a framed construction panel 1200, a framed lintel panel 1300 or a lintel panel 300 secured along an edge of a major face of one or more of the construction panels 200. The means by which the panels are interconnected are explained below. It is envisaged that the wall construction 800 can also include other construction panels 200 or framed construction panels 1200.

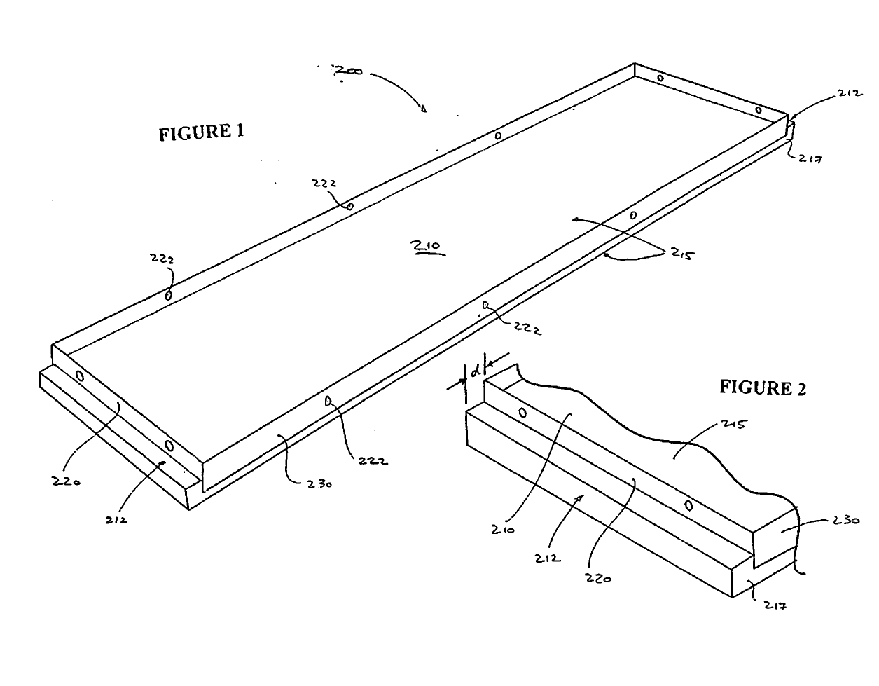

It is envisaged that such a wall construction 800 will be used to secure a pair of construction panels 200 to a structural member 1020 (as shown in FIG. 1), while concealing the structural member 1020 from the outside to present a clean cement surface from the outside. It is further envisaged that such a wall construction 800 can be used at corners of buildings, to conceal the structural member 1020 from the outside. This may be helped by adjacent construction panels having extended portions 212 that have unequal distances on opposite sides, so that the extended portion 212 of one construction panel 200 will overlap the structural member 1020 more than the adjacent extended portion of the adjacent construction panel.

It is envisaged that lintel panels 300 could also be secured to structural members 1210 in the same way as construction panels 200 to form a wall construction. These lintel panels 300 could similarly be secured to any of the other panels, as long as the adjacent edges of their respective wall members are traversed by a framing support member 230, 330, 1230, 1330 as detailed below.

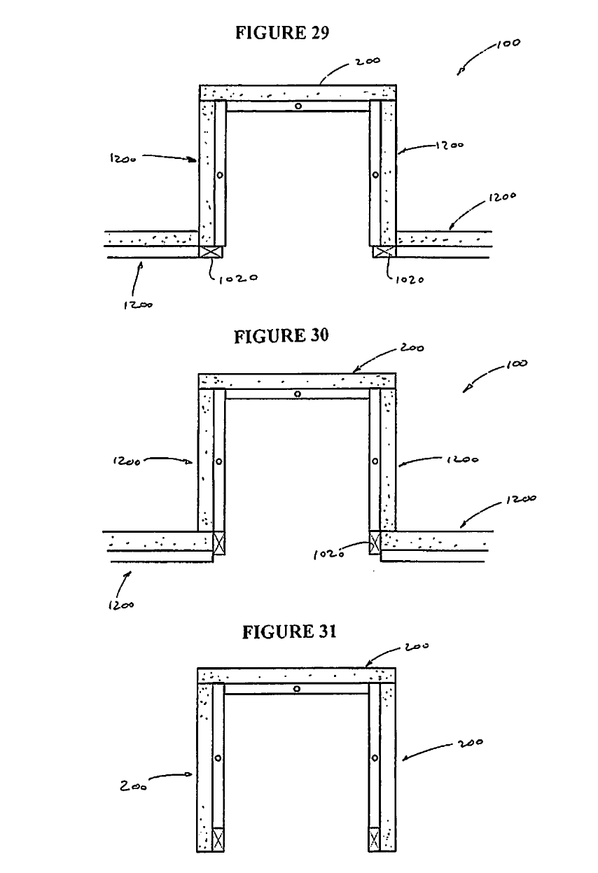

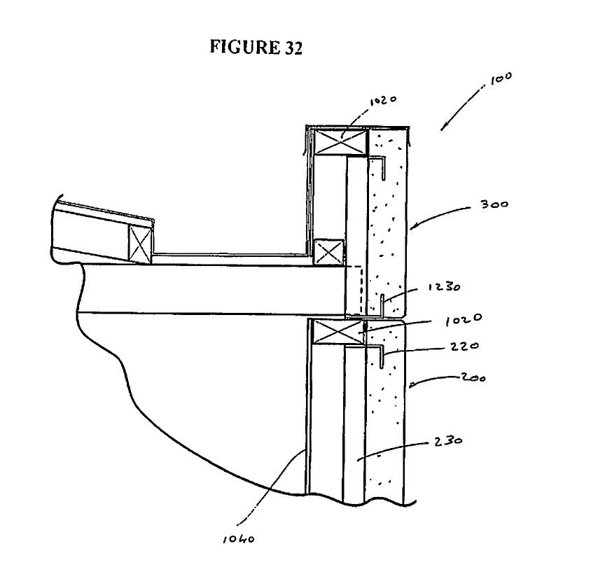

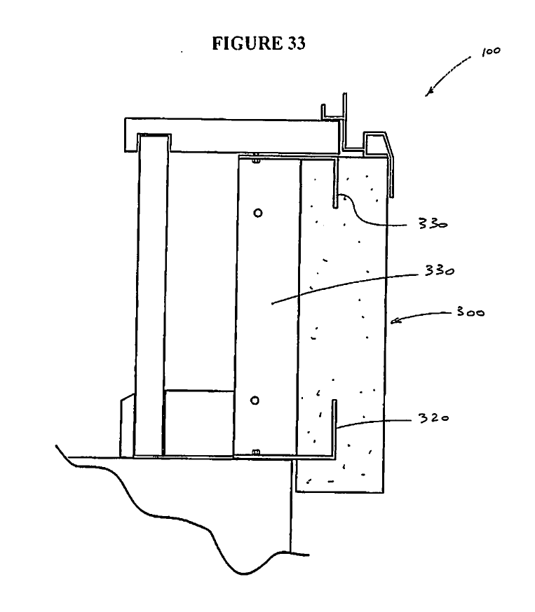

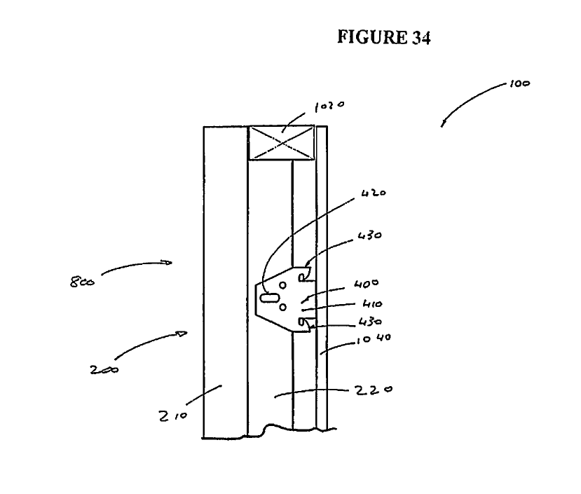

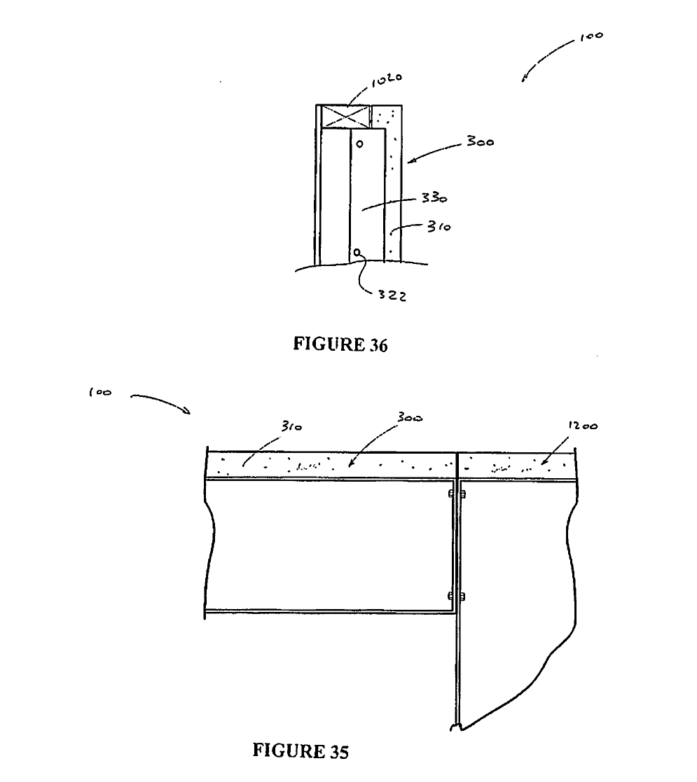

The lintel panels 300 and/or construction panels 200 may be used in a wide variety of configurations (as shown in FIGS. 29-31) to extend their wall members around structural members 1020 to present a clean cement outside face to the outside of a building 1000.

It is further envisaged that any of the panels could be secured to each other to form a wall construction 800 by inserting bolts through their framing support members 230, 330, 1230, 1330 to secure them to each other. For example, the framing support member 230 of a construction panel 200 could be secured to a framing support member 230 of an adjacent construction panel 200 directly.

A construction panel 200 could also be secured to an adjacent framed construction panel 1200 at those edges which have a framing support member 230, 1230 extending along them. In such a case, the minor faces 217, 1217 of the wall members 210, 1210 of the adjacent construction panel 200 and framed construction panel 1200 will abut each other, with the edge of their major faces 215, 1215 disposed proximate each other.

In the same way, the construction panel 200 can also be secured to an adjacent lintel panel 300 or framed lintel panel 1300. However, in such a case, the lintel panel 300 or framed lintel panel 1300 would not be secured over the entire length of the construction panel 200.

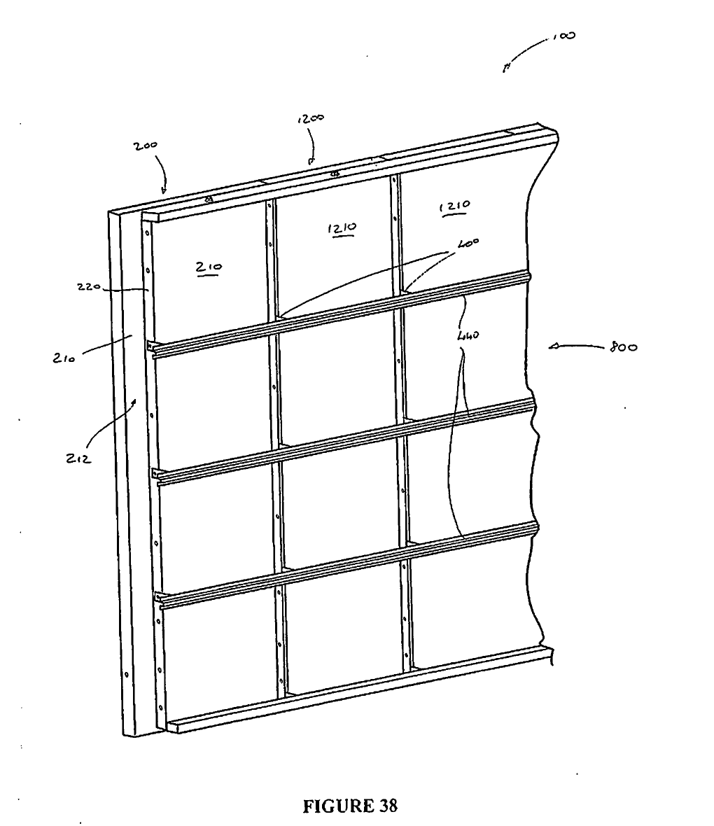

As shown in FIG. 38, where the framing support members 230, 1230, 330, 1330 of adjacent panels 200, 300, 1200, 1300 are secured to each other, a plurality of mounting arrangements 400 can be secured between or at the framing support members 230, 1230, 330, 1330.

The mounting arrangements 400 are generally in horizontal alignment when used to construct a wall, so that elongate support battens 440 in the form of “Rondo” battens can be mounted to them. Drywall members 1040 or the like can then be attached to the support battens. When drywall members 1040 are attached to the support battens 440, they will enclose a cavity between the wall member 210, 310, 1210, 1310 and the drywall members 1040, suitable for insertion of insulative material 450.

In the same way, mounting arrangements 400 can be mounted between or at a structural member 1020 and a support member 220, 320 to hold the support batten at its termination against the structural member 1020.

A wall construction according to the invention can further comprise a load bearing mounting arrangement 600 as described above. The load bearing mounting arrangement 600 is also secured between or onto a support member 220, 320 or framing support member 230, 330, 1230, 1330.

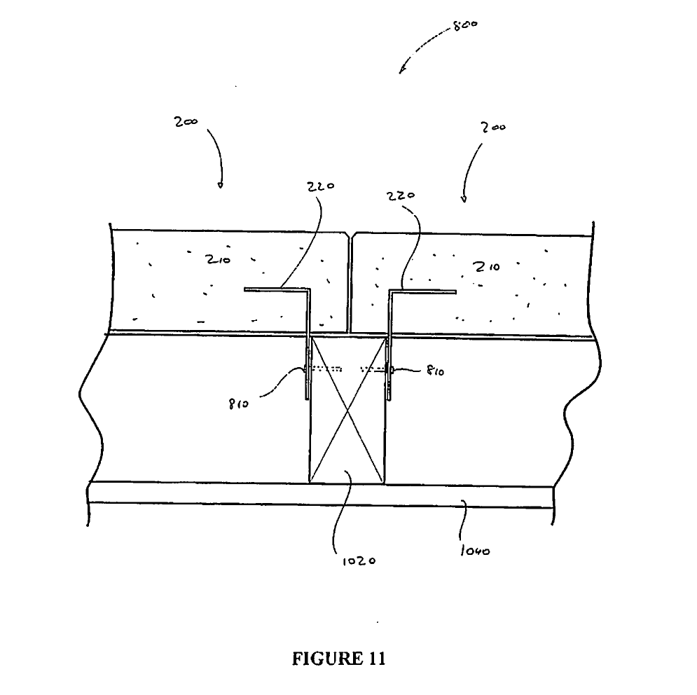

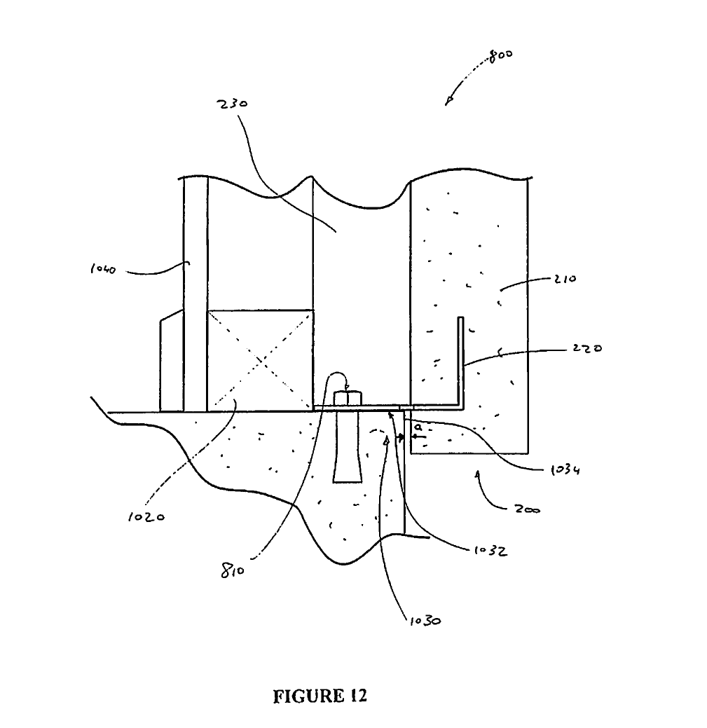

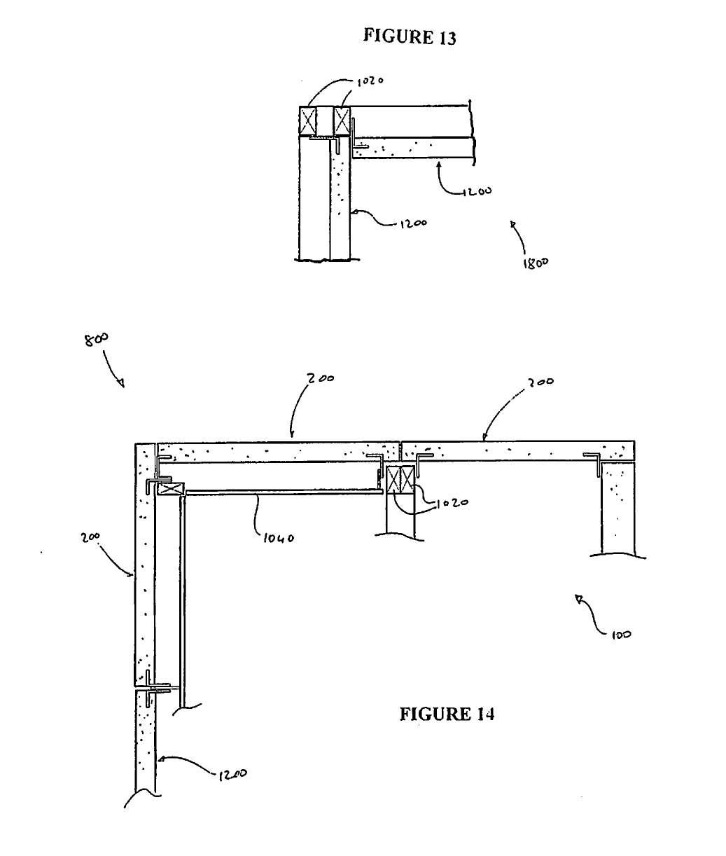

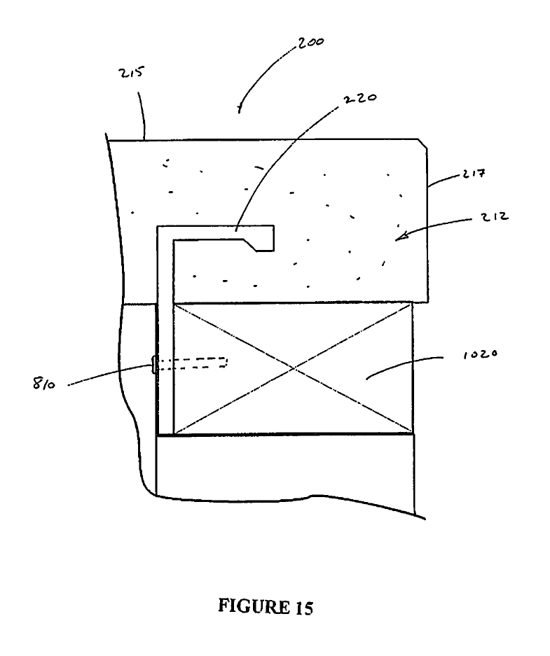

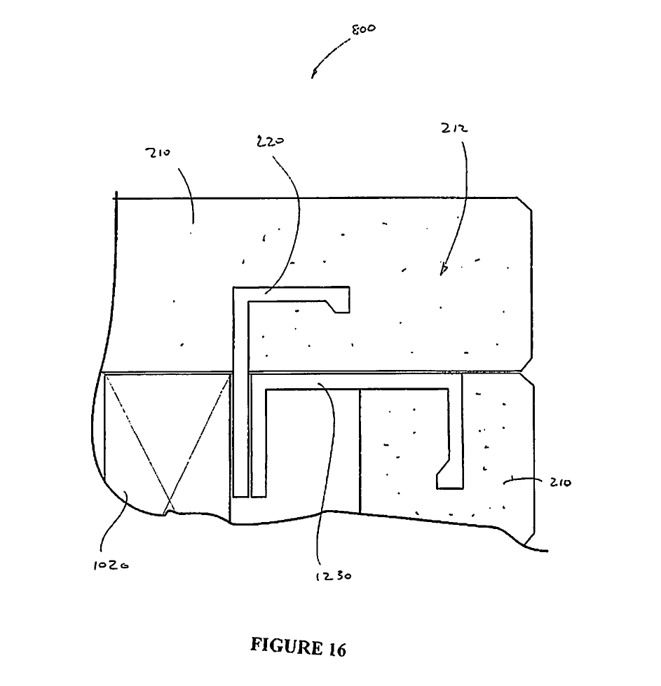

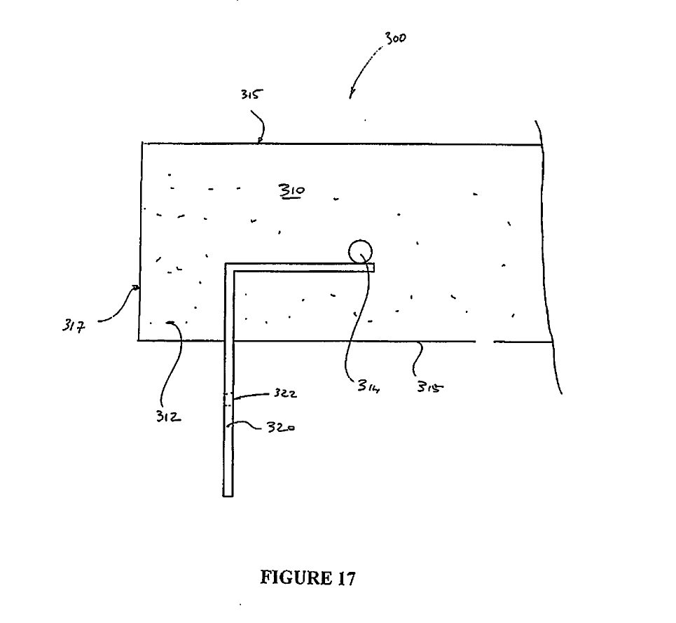

Construction panels 200 or lintel panels 300 may be mounted onto a lower supporting structural formation 1030 to form a wall construction 800. The supporting structural formation 1030, for example in the form of a foundation (as shown in FIG. 12, whether pre-cast or laid in situ), comprises an upper supporting surface 1032 defining an edge formation 1034. A support member 220,320 of a construction panel 200 or lintel panel 300 is aligned to extend substantially horizontally from the wall panel 210, 310 and is supported by the upper supporting surface 1032. The extended portion 212, 312 extends downwardly past the edge formation 1034 to below the upper supporting surface 1032.

In a preferred embodiment, a small gap (shown as arrow “a” in FIG. 12) is left between the wall panel 210,310 and the edge formation 1034 to allow for ventilation through the wall construction 800 from the bottom of the wall panel 210,310.

The support member 220, 320 is secured to the supporting structural formation 1030 by a securing arrangement 810 in the form of a nut and bolt arrangement. The construction panels 200 or lintel panels 300 mounted on the supporting structural formation 1030 can be secured to any other of the panels 200,300,1200,1300 as described above, and may include mounting arrangements 400 and/or load bearing mounting arrangements 600 and/or cladding elements 500 secured to the construction panels 200 or lintel panels 300 as described.

A framed wall construction 1800 is provided by securing a pair of framed construction panels 1200 alongside each other with a securing arrangement 1810. The securing arrangement 1810 can be in the form of a nut and bolt arrangement. The nut and bolt arrangement is inserted through holes or slots in the framing support members 1230 to secure adjacent framing support members 1230 on adjacent framed construction panels 1200 to each other.

In the same way that the wall construction 800 is securable to adjacent panels 200, 300, 1200, 1300, the framed wall construction 1800 will also be securable to adjacent panels 200, 300, 1200, 1300. Similarly, mounting arrangements 400 and/or load bearing mounting arrangements 600 are securable between or at the framing support members 230, 1230, 330, 1330. The framed construction panels or lintel panels 1200, 1300 can be secured to any other of the panels 200,300,1200,1300 as described above, and may include mounting arrangements 400 and/or load bearing mounting arrangements 600 and/or cladding elements 500 secured to the framed construction panels 200 or framed lintel panels 300 as described.

The basic panels 200, 300, 1200, 1300 may be used in similar ways to provide a wall construction 800 and framed wall construction 1800 as described above, as well as floor constructions 700, framed floor constructions 1700, roof constructions 900 and framed roof constructions 1900.

However, it is envisaged that where the panels are created for use as a roof constructions 900 or framed roof constructions 1900, the cast planar wall member can be moulded specially to resemble a plurality of roof tiles at least on the outer surface thereof. In this way, a roof constructions 900 or framed roof constructions 1900 can look like an ordinary roof.

A floor construction 700 comprises a supporting structural formation 1030 and at least one construction panel 200. The supporting structural formation 1030 comprises an upper supporting surface 1032 defining an edge formation 1034. The construction panel 200 is disposed with its extended portion 212 abutting against the upper supporting surface 1032 to support the wall member 210 vertically. The support member 220 of the construction panel 200 abuts against the edge formation 1034 of the supporting structural formation 1030, to seat firmly against it. The wall member 210 or the support member 310 can be secured to the supporting structural formation 1030 by a securing arrangement 710 such as a nut and bolt arrangement, a rivet arrangement (not shown) or rawl bolt-type arrangement.

A plurality of construction panels 200, disposed alongside each other, can be engaged with the supporting structural formation 1030. Each of the adjacent construction panels 200 can be secured to each other as described above. It is envisaged that framed construction panels 1200 can be secured end- to end alongside the construction panels 200 as described above to extend the floor area of the floor construction 700. it is envisaged that construction panels and framed construction panels used in a floor construction will include securing extensions 216, 1216 as described above, that extend from a minor face 217, 1217 of the construction panel 200 or the framed construction panel 1200 (“the construction panels’). The construction panels are disposed end to end, with their respective adjacent ends being supported on a supporting structural formation 1030. The wall members 210, 1210 of the panels 200, 1200 need not abut with each other, and a small gap can be left between them (as shown for a similar framed floor construction in FIGS. 22 and 23). The securing extensions 216 extend into the gap between the panels, and can be held in place by a settable cementitious mix which can be cast in place in situ. In this way, the panels 200, 1200 are secured in place as a floor construction 700.

A floor construction 700 on an upper level of a building 1000 may also be a roof construction 900 for a lower level of the building. In such a case, it is envisaged that the floor construction 700 could also include mounting arrangements 400 and load bearing mounting arrangements 600 secured to the support members 220.

The mounting arrangements 400 can act as mounting points for support battens 440 as described above, and drywall members 1040 in the form of as ceiling boards can be mounted to the support battens 440. Further, the load bearing mounting arrangements 600 can be used for supporting larger items, such as heavy lights (not shown) and the like.

Where additional rigidity is required for the floor, a pair of construction panels 200 or framed construction panels 1200 may be secured to each other with their major faces having support members extending therefrom facing away from each other (i.e. with the clean major faces abutting each other). They can be secured to each other by inserting a securing arrangement 710 such as a nut and bolt arrangements through securing formations 218, 1218 to double the thickness of the wall panel. The support members 220 and framing support members 1230 can then be used to mount drywall members 1040 in the form of flooring (not shown) above the wall members 210, 1210, and ceiling board below the wall members 210, 1210.

According to another aspect a framed floor construction 1700 is comprised of a supporting structural formation 1030, said supporting structural formation 1030 supporting a plurality of framed construction panels 1200 disposed alongside each other and secured to each other at their framing support members 1230 by a nut and bolt arrangement similar to that described for the framed wall construction 1800, and with the framing support members 1230 of adjacent framed construction panels 1200 abutting each other. The adjacent abutting framing support members 1230 are secured to each other by at least one securing arrangement 1710 in the form of a nut and bolt arrangement.

The framed floor construction 1700 is similar to the floor construction in many respects, including the provision of securing extensions 1216 that can be cast into place in situ. In one embodiment and similar to the floor construction 700 described above, the abutting major faces of adjacent wall members 1210 can be secured together to increase the rigidity of the framed floor construction 1700.

Construction panels 200 and framed construction panels may similarly be used to provide a roof construction 900 and/or a framed roof construction 1900.

To provide a roof construction 900, a plurality of construction panels 200 as described above are provided. In one embodiment, they are disposed with the edges of the major faces 215 of adjacent planar wall members 210 of construction panels 200 proximate each other. A structural member 1020 is held intermediate the support members 220 most proximate the abutting edges of the adjacent wall members 210. The construction panels 200 are also secured to the structural member 1020 by means of a securing arrangement 910, most preferably in the form of a nut and bolt arrangement

The roof construction 900 further comprises a plurality of construction panels 200 disposed with an edge of the major faces 215 of adjacent wall members 210 proximate each other, and with the minor faces 217 of adjacent wall members 210 abutting each other.

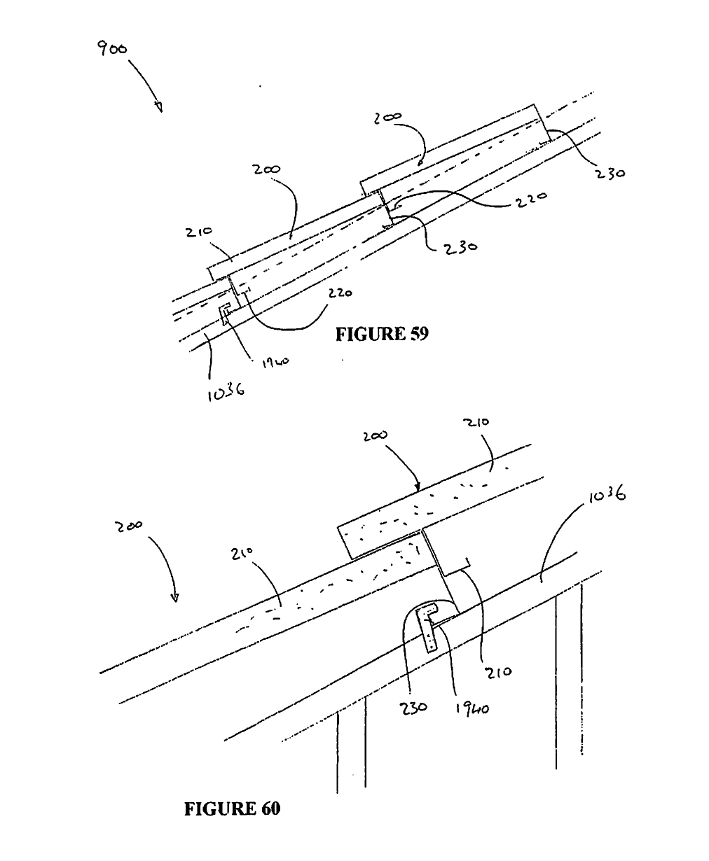

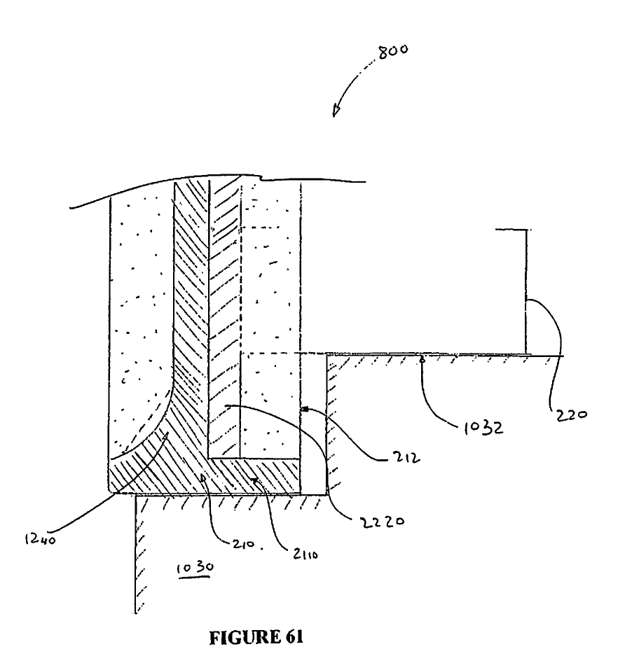

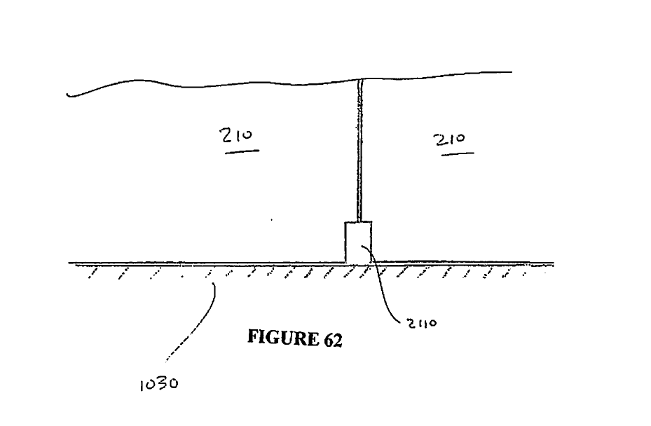

The minor faces of the wall members 210 of construction panels 200 can abut each other, or the wall members can be disposed to overlap each other as shown in FIGS. 59 and 60. In such a configuration, the extended portions 212 are used to overlap with the lower adjacent similar wall member 210.

It is envisaged that in such a configuration the adjacent wall members 210 to the side of the will be sealed against each other by a scaling arrangement described below.

The roof construction 900 can also further include at least one framed construction panel 1200 as described below, secured to the construction panel 200 in a typical manner described above. The roof construction 900 further includes at least one securing arrangement 910 for securing a framed construction panel 1200 to the construction panel 200 at their adjacent support members 220, 230 & 1230. They can also be sealed against each other as described below.

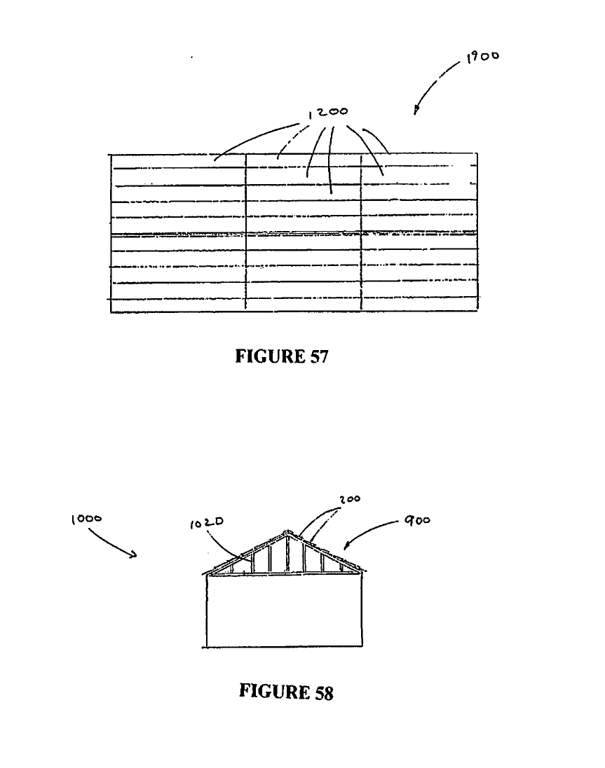

A framed roof construction 1900 (shown in FIG. 57) comprises a plurality of framed construction members 100 as described above disposed with the framing support members 1230 of the adjacent framed construction panels 1200 abutting each other; and wherein the adjacent abutting framing support members 1230 are secured to each other by means of a securing arrangement 1910. It is envisaged that the gap between the respective wall members 1210 will be sealed by one or more sealing arrangements as described below.

It is envisaged that such a roof construction 900 and/or framed roof construction 1900 can also include one or more locating members 940, for securing to a roof truss 1036 so that the support members 220, 230 1230 can be located against these to prevent the construction panels 200 and/or framed construction panels 1200 from slipping downwardly off the roof truss 1036 The locating members 940, may also provide securing formations (not shown) for securely coupling the construction panels 200 and/or framed construction panels 1200 to one or more roof trusses 1036.

In one preferred embodiment, the roof construction 900 and/or framed roof construction 1900 can include fastening means (not shown) in the form of a collar tie 930 for fastening the roof construction 900 and/or framed roof construction 1900 to a wall construction 800 or framed wall construction 1800. Further, the roof construction 900 includes mounting bracket (not shown) for mounting the roof construction 900 to one selected from an adjacent wall construction 800 and an adjacent framed wall construction 1800.

Both the roof construction 900 and the framed roof construction 1900 have similar features. For instance, both of them include mounting arrangements 400 as described above secured between or at a support member 220 or framing support member 1230. Both of them can mount support battens 440 on their mounting arrangements 400, and both of them can support drywall members 1040 in the form of ceiling board from their support battens 440 similarly to that described for the floor construction 700 and the wall construction 800. Both of them can include load bearing mounting arrangements 600 mounted to the support members 220 and framing support members 1230 as described above. Both of them can also include a cladding element 500 secured to a major face 215, 1215 (and preferably an outer major face) of their wall members 210, 1210.

Where additional rigidity is required, it is envisaged that the wall members 210, 1210 of a pair of construction panels 200 or framed construction panels 1200 may be secured to each other with their major faces 215, 1215 abutting each other as described above for floor constructions. The wall members can then be secured to each other by a securing arrangement 910, 1910 such as a nut and bolt arrangement.

It is further envisaged that the roof construction and framed roof construction can include a lintel panel 300 or a framed lintel panel 1300 secured to the construction panel 200 or framed construction panel in a similar fashion to that described for the wall construction 800.

A framed roof construction 1900 and a roof construction can also be secured to each other at adjacent framed support members 230, 1230.

In one embodiment, it is envisaged that the construction panels 200 and/or the framed construction panels 1200 can include wall members 210, 1210 that have been moulded to look like traditional roofing (for example in the shape of laid roof tiling or the like). In this way, the buildings made using the construction panels will not be as easy to distinguish from traditional housing, if conformity of aesthetics is important.

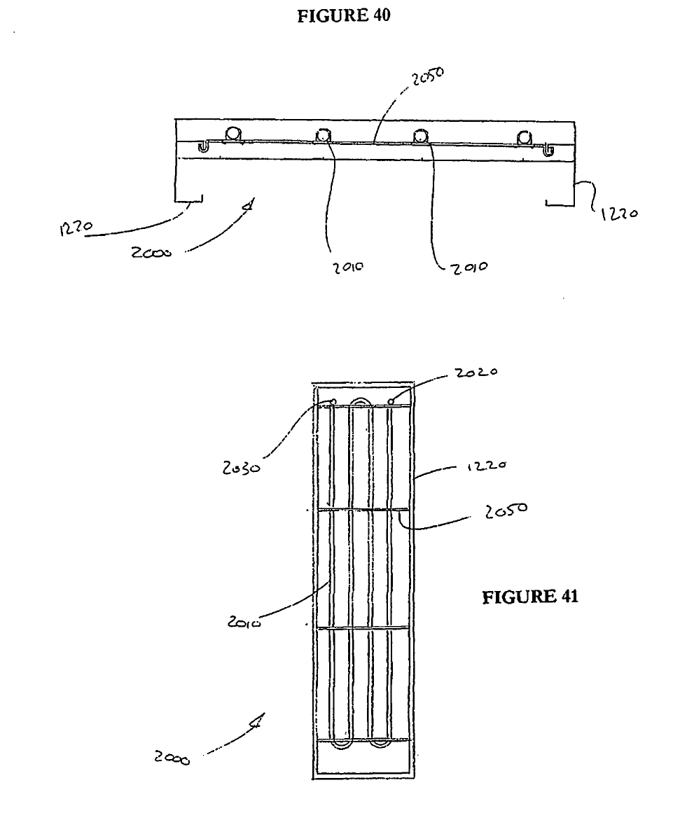

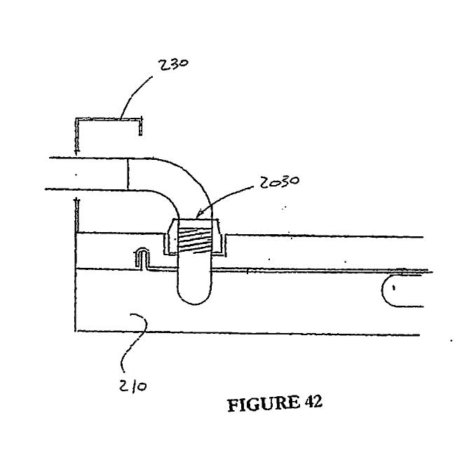

It is further envisaged that in another embodiment, any of the panels (framed lintel panel 1300, framed construction panel 1200, cladding element 500, lintel panel 300, and construction panel 200—“the panels”) could further comprise a heating arrangement 2000 as shown in FIG. 40-42. The heating arrangement 2000 is preferably integrally formed with the panel, and comprises a length of piping 2010 suitable for the passage of heated fluid, with an inlet passage 2020 and an outlet passage 2030 to and from the panel. The piping is preferably configured as several lengths of parallel pipes connected to each other in an S-type or coiled-type formation, and is supported by a piping support frame.

It is envisaged that heated water from a building's geyser could be piped through the piping 2010 to heat up the construction. Alternately, thermal energy absorbed by the panels could be transferred to water in the piping 2010, to reduce water heating costs and keep the construction cool.

In a preferred embodiment, the support members of the various panels and framed panels can be made of thin gauge galvanised sheet metal that has been bent to various cross sectional shapes, and preferably having a channel section, to stiffen them structurally. In this format, the cost and weight of the panels may be reduced. In this regard, a gauge of between 0.3 and 3 millimetres, and preferably about 0.5 millimetres is preferred.

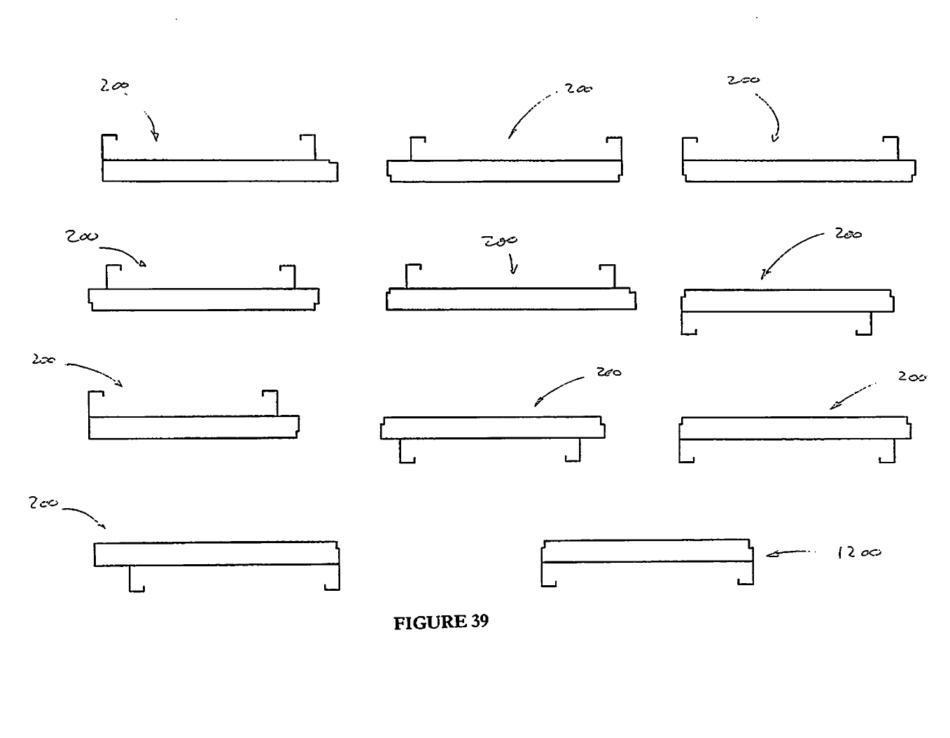

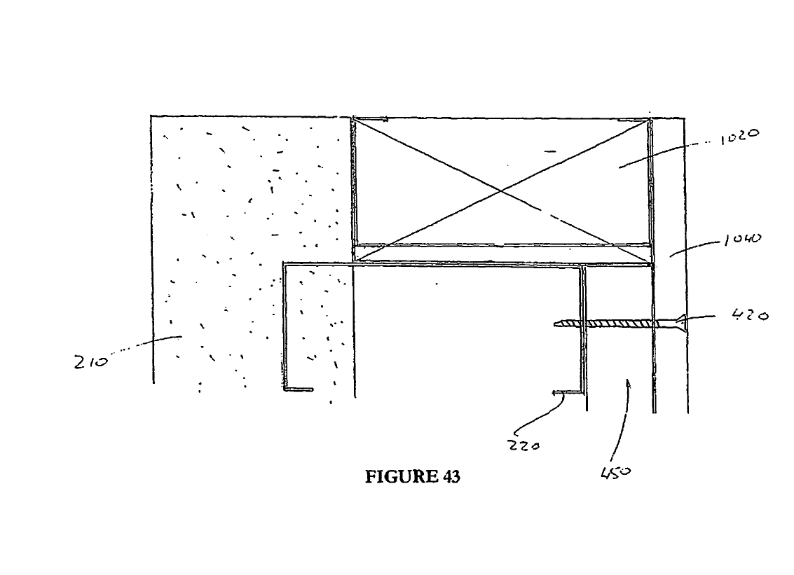

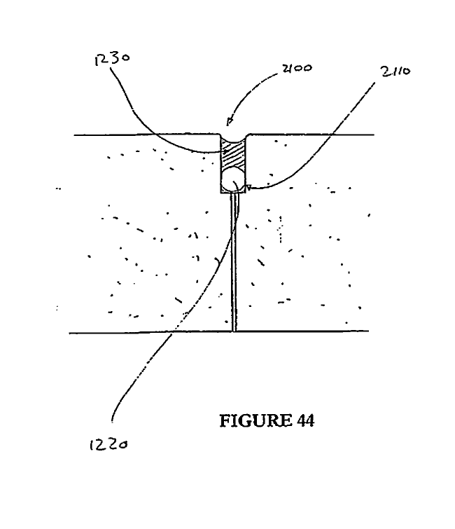

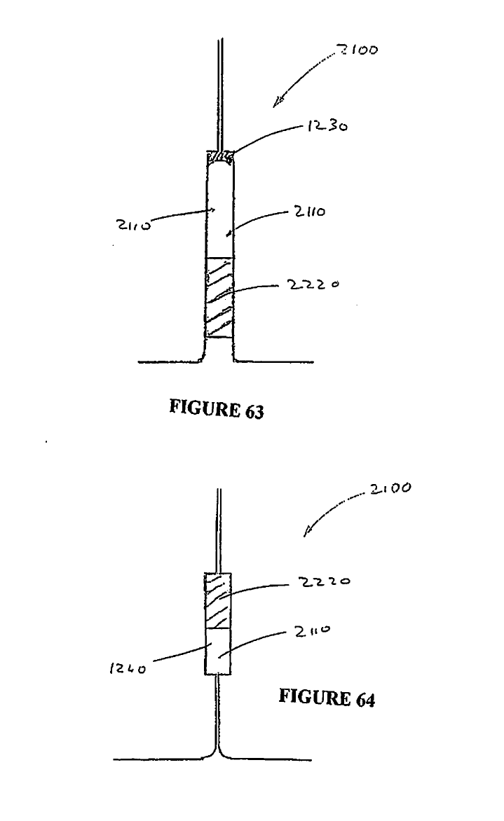

In another preferred embodiment shown in FIG. 44, the framed or unframed wall, roof or floor constructions can include a sealing arrangement 2100. Each of the framed or unframed construction panels 200, 1200 and/or lintel panels 300, 1300 includes a recess 2210 along an edge of the wall member 210, 310, 1210, 1310 and also extends along a major face opposed to the major face from which the framed or unframed support members extend as shown in FIG. 63. The recess could also extend along a free edge of the major face from which the support members extend as shown in FIG. 39. Preferably, these recesses form a larger combined recess when placed adjacent a similar recess from another panel.

In operation, it is envisaged that the gap between two panels could be sealed by a sealing member 122 such as an elongate rubber or plastic member that can be pushed into this enlarged recess, or between the recess and an adjacent flat surface. It is further envisaged that the gap between panels formed by the enlarged recess can be filled up by a settable sealing filler composition 1230, which can also be waterproof. In this way, the settable sealing filler composition can be smoothed before setting to present a smooth face for painting or otherwise instead of a ridge.

In another embodiment, as shown in FIG. 64 the recess could extend along one or more minor faces of the wall members. When the minor face is located adjacent similar minor face, the adjacent recesses create a larger enclosed chamber 1240. If the outside of the construction is wetted (for example by rain), water surface tension could draw water into the small gap between the wall members by capillary action. However, when the gap between the wall members is widened at the chamber, it is expected that such a widening will at least partially reduce the capillary action drawing water between the wall members. It is envisaged that a sealing member 122 could be used in addition to seal the gap at an inner side of the chamber 1240.

As will be appreciated, the construction of a building 1000 may be facilitated by the using at least one, if not all, of the modular components described above, including a wall construction 800, a floor construction 700, a roof construction 900, a framed wall construction 1800, a framed floor construction 1800, and a framed roof construction 1900 (the modular components”) as described above, all as part of a modular construction system 100.

In a most preferred embodiment of the construction system, at least some or all of the modular components will have standardised sizes. In particular, it is envisaged that the width fo the wall members will be standardised. The width will be standardised at between 300-700 mm, more preferably between 500-650 mm, and most preferably at about 600 mm.

In an alternative embodiment, it is envisaged that the inside distance between a support member and/or framing support member, and a support member and/or framing support member located at an opposed edge of the major face, can also be standardised. However, this is more difficult to use as a system, and may not result in buildings that are as aesthetically desirable.

The construction system described herein will allow relative freedom of architectural design, relative ease of erection, relatively low cost and structural integrity. It is envisaged that houses using the modular construction system 100 may be designed architecturally, while having the modular nature of the system in mind. Once the building 1000 has been designed, it is envisaged that at least some of the panels and accessory components described above will be delivered as a modular construction kit for erection on site. Alternatively, such a modular construction kit may be sourced at building hardware suppliers as individual standard parts, for assembly according to an architectural drawing.

Further, it will appreciated that the modular construction system may comprise additional accessories, but still utilise the same construction principles as set out above.

By using construction panels and framed construction panels as described, a construction can also be built that is relatively strong in relation to other lightweight cladding, such as weatherboard. This is because the construction panels and framed construction panels not only cover the area between the structural members 1020 and/or roof trusses 1036, but also strengthen their support. It is envisaged that the construction panels and/or framed construction panels will be at least partially load bearing in their own right in operation. The cast concrete or cement mixture of the wall members are strong in compression, and help prevent buckling of the structural members, while the support members are strong in tension. In this way, the construction panels and framed construction panels help with the bracing of the building, and can allow for smaller structural members to be used in the construction of a building. Such features are especially useful in extreme situations such as earthquakes, where a building can be subjected to loadings that it was not designed for.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A construction panel suitable for use in a modular construction process, said construction panel comprising:
a) a cast concrete wall member defining two opposed major faces and at least one edge;
b) at feast one partially embedded support member extending from one major face of the wall member at a distance from at least one edge of at least one major face;
c) wherein the support member is composed of a fibrous composition.

2. A construction panel as claimed in claim 1, wherein the wall member defines a plurality of edges.

3. A construction panel as claimed in claim 1, wherein at least part of at least one of the edges of the major faces is at least partially unimpeded.

4-7. (canceled)

8. A construction panel as claimed in claim 1, wherein the extension of the wall member between the support member and the edge of the wall member defines an extended portion.

9. A construction panel as claimed in claim 8, wherein the extended portion is a linear lip.

10. A construction panel as claimed in claim 8, wherein the extended portion of the wall member extends around a plurality of edges of the wall member.

11. A construction panel as claimed in claim 8, wherein the extended portion of the wall member extends around all the edges of the wall member.

12. A construction panel as claimed in claim 1, wherein the construction panel comprises support members extending along the length of opposed edges of the wall member, and the support members extend from the major face of the wall member at unequal distances from the respective edges of the major face.

13. A construction panel as claimed in claim 8, wherein the construction panel further comprises at least one partially embedded framing support member extending from one major face of the wall member at at least one edge of at least one major face.

14. A construction panel as claimed in claim 13, wherein the extended portion extends around at least some of the edges of the wall member, and a framing support member extends around at least one of the remaining edges of the wall member at the edge of the wall member.

15. A construction panel as claimed in claim 13, wherein the framing support member and the support member are connected to each other.

16. A construction panel as claimed in claim 1, wherein the wall member is substantially rectangular in shape.

17. A construction panel as claimed in claim 16, wherein the wall member is rectangular in shape.

18. A construction panel as claimed in claim 1, wherein at least one support member is substantially L-shaped in cross section.

19. A construction panel as claimed in claim 1, wherein at least one support member is substantially C-shaped in cross section.

20. A construction panel as claimed in claim 1, wherein at feast one support member is substantially channel shaped in cross section.

21. A construction panel as claimed in claim 1, wherein the wall member includes internal reinforcing inserts.

22. A construction panel as claimed in claim 8, wherein the extended portion of the wall member includes reinforcing inserts.

23. A construction panel as claimed in claim 8, comprising reinforcing inserts that extend between the extended portion and the rest of the wall member.

24. A construction panel as claimed in claim 21, wherein the reinforcing inserts extend at least partially from the wall member as securing extensions.

25-27. (canceled)

28. A construction panel as claimed in claim 21, wherein the reinforcing inserts are composed of a fibrous composition.

29. A construction panel as claimed in claim 21, wherein the reinforcing inserts are composed of one or more selected from:
a) glass fibre; and
b) carbon fibre.

30. A construction panel as claimed in claim 21, wherein the reinforcing inserts are pre-stressed.

31-33. (canceled)

34. A construction panel as claimed in claim 30, wherein the support member is composed of a pultruded fibre composition.

35-36. (canceled)

37. A construction panel as claimed in claim 13, wherein a support member extends along one edge of the wall member, and one selected from a support member and a framing support member extends along an opposed edge of the wall member.

38-39. (canceled)

40. A construction panel as claimed in claim 1, wherein the width of the wall member from edge to edge is between 300-900 mm.

41-48. (canceled)

49. A construction panel as claimed in claim 1, wherein the construction panel includes securing formations for allowing cladding elements to be secured to at least one major face of the wall panel.

50. A construction panel as claimed in claim 1, wherein the support members include batten support formations for supporting support battens.

51. A construction panel as claimed in claim 13, wherein the framing support members include batten support formations for supporting support battens.

52. A construction panel as claimed in claim 1, wherein the construction panel further comprises an integrally formed heating arrangement.

53. A construction panel as claimed in claim 52, wherein the heating arrangement includes a length of piping suitable for the passage of heated fluid, with an inlet passage and an outlet passage.

54. A construction panel as claimed in claim 53, wherein the piping is configured as several lengths of parallel pipes connected to each other.

55-61. (canceled)

62. A construction panel as claimed in claim 1, wherein the wall member includes a recess along an edge adapted for operationally receiving a sealing arrangement.

63. A construction panel as claimed in claim 62, wherein the recess is along an edge on a major face opposed to the major face from which the support members extend.

64. A construction panel as claimed in claim 1, wherein the wall member includes a recess along at least one minor face, said recess adapted for operationally receiving a sealing arrangement.

65. A construction panel suitable for use in a modular construction process, said construction panel comprising:
a) a cast planar wall member defining two opposed major faces;
b) at least one partially embedded support member most proximate an edge of the wall member extending from one major lace of the wall member;
c) wherein the wall member extends outwardly along the plane of the wall member from the support member to define an extended portion
d) wherein the support member is composed of a fibrous composition.

66. A construction panel as claimed in claim 65, wherein the edges of the extended portion are unimpeded, to thereby allow for the snug engagement of the extended portion against one or more selected from the group of:
a) construction framing;
b) the extended portion of a similar construction panel;
c) the support member of a similar construction panel; and
d) an edge of a floor construction.

67-159. (canceled)

160. A wall construction comprising:
a) at least a plurality of construction panels as claimed in claim 1 disposed with the edges of the major faces of adjacent planar wall members at least partially abutting each other; and
b) a structural member disposed intermediate the support members most proximate the abutting edges of the adjacent wall members;
c) wherein the construction panels are secured or securable to the structural member by at least one securing arrangement.

161. A wall construction as claimed in claim 160, wherein the wall construction comprises, at a position secured along at least part of an edge of a major face of at least one construction panel, one or more selected from a framed construction panel comprising:
a) a cast planar wall member defining 2 opposed major faces and at least one minor face; and
b) a pair of partially embedded framing support members extending from at least one major face of the wall member proximate opposed edges of the wall member.

162-176. (canceled)

177. A wall construction as claimed in claim 161, wherein the wall construction includes a sealing arrangement between one or more selected from:
a) adjacent construction panels; and
b) adjacent construction panels and framed construction panels.

178. A wall construction as claimed in claim 177, wherein the sealing arrangement comprises a sealing member received into a combined recess formed by adjacent recesses of adjacent panels.

179. A wall construction as claimed in claim 177, wherein the sealing arrangement comprises a settable sealing filler composition received into a combined recess formed by adjacent recesses of adjacent construction panels.

180. A wall construction comprising:
a) a supporting structural formation comprising an upper supporting surface defining an edge formation; and
b) at least one construction panel as claimed in claim 1,
c) wherein said support member extends substantially horizontally from the wall member and is supported by the upper supporting surface, and the extended portion of the construction panel extends downwardly past the edge formation to below the upper supporting surface.

181. A wall construction as claimed in claim 180, wherein the wall construction includes a securing arrangement for securing the support member to the supporting structural formation.

182. A wall construction as claimed in claim 180, wherein the wall member is distanced from the edge of the supporting structural formation provide ventilation through the wall construction.

183. A wall construction as claimed in claim 180, wherein the wall construction comprises one or more selected from a frame construction panel comprising:
a) a cast plan wall member defining to opposed major faces and at least one minor face; and
b) a pair of partially embedded framing support members extending from at least one major face of the wall member proximate opposed edges of the wall member.

184. A floor construction comprising:
a) a supporting structural formation comprising an upper supporting surface defining an edge formation; and
b) at least one construction panel as claimed in claim 1;
c) wherein said construction panel is disposed with its
i) extended portion abutting against the upper supporting surface to support the wall member vertically, and
ii) said support member abutting against the edge formation of the supporting structural formation.

185. A floor construction as claimed in claim 180, wherein the floor construction comprises one or more selected from a framed construction panel comprising:
a) a cast plan wall member defining to opposed major faces and at least one minor face; and
b) a pair of partially embedded framing support members extending from at least one major face of the wall member proximate opposed edges of the wall member.

186. A floor construction as claimed in claim 184, wherein the floor construction comprises a plurality of construction panels disposed with an edge of the major faces of adjacent wall members proximate each other.

187. A floor construction as claimed in claim 186, wherein the floor construction comprises a plurality of construction panels disposed with the minor faces of adjacent wall members abutting each other.

188. A floor construction as claimed in claim 184, wherein the floor construction comprises at least one framed construction panel secured along an edge of a major face of at least one construction panel.

189. A floor construction as claimed in claim 185, wherein the plurality of construction panels disposed with an edge of their major faces proximate each other are secured to each other by a securing arrangement at abutting support members.

190-192. (canceled)

193. A floor construction as claimed in claim 184, wherein the floor construction also acts as a ceiling construction for a construction level below the floor construction.

194. A floor construction as claimed in claim 184, wherein the floor construction includes a mounting arrangement secured to at least two support members of adjacent construction panels.

195. A floor construction as claimed in claim 194, wherein the floor construction further comprises support battens mounted between at least two mounting arrangements.

196. A floor construction as claimed in claim 195, wherein the wall construction comprises a drywall member mounted to the support battens.

197-201. (canceled)

202. A floor construction as claimed in claim 187, wherein the floor construction includes a sealing arrangement between adjacent construction panels and/or adjacent construction panels and framed construction panels.

203. A floor construction as claimed in claim 202, wherein the sealing arrangement comprises a sealing member received into a combined recess formed by adjacent recesses of adjacent panels.

204. A floor construction as claimed in claim 202, wherein the sealing arrangement comprises a settable sealing filler composition received into a combined recess formed by adjacent recesses of adjacent panels.

205. A roof construction comprising
a) a plurality of construction panels as claimed in claim 1 disposed with the edges of the major faces of adjacent planar wall members proximate each other; and
b) a structural member disposed intermediate the support members most proximate the abutting edges of the adjacent wall members; and
c) wherein the construction panels are secured to the structural member by means of a securing arrangement.

206. A roof construction as claimed in claim 205, wherein the roof construction comprises one or more selected from a framed construction panel comprising:
a) a cast plan wall member defining to opposed major faces and at least one minor face; and
b) a pair of partially embedded framing support members extending from at least one major face of the wall member proximate opposed edges of the wall member

207-208. (canceled)

209. A roof construction as claimed in claim 206, wherein the extended portion of the wall members overlap with a proximate wall member.

210-220. (canceled)

221. A roof construction as claimed in claim 205, wherein at least one of the cast planar wall members is moulded to resemble a plurality of roof tiles on at least one side.

222. A roof construction as claimed in claim 205, wherein the roof construction includes a sealing arrangement between adjacent one selected from the construction panel and the framed construction panel and one selected from a construction panel and a framed construction panel.

223-286. (canceled)

287. A building construction comprising at least one or more selected from a wall construction as claimed in claim 1.

288. (canceled)

289. A modular construction system comprising a construction panel as claimed in claim 1, and:
a) a cast plan wall member defining to opposed major faces and at least one minor face; and
b) a pair of partially embedded framing support members extending from at least one major face of the wall member proximate opposed edges of the wall member.

290-291. (canceled)

292. A modular construction system as claimed in claim 289, wherein the width of the wall member is standardised for each of:
a) said construction panel; and
b) said framed construction panel.

293. (canceled)

294. A modular construction system as claimed in claim 292, wherein the width of the wall member is standardised at between 300-700 mm.

295. A modular construction system as claimed in claim 294, wherein the width of the wall member is standardised at between 500-650 mm.

296. A modular construction system as claimed in claim 295, wherein the width of the wall member is standardised at about 600 mm.

297-302. (canceled)
